(19) United States
(12) Patent Application Publication
(10) Pub. No.: US 2026/0325405 A1
(43) Pub. Date: Oct. 22, 2026

(54) Closed-System Infusion Adapter with High-Strength Connection to an Infusion Fluid Container

(71) Applicant: Becton, Dickinson and Company, Franklin Lakes, NJ (US)

(72) Inventors: Mukilan Balamurugan, Theni (IN); Edwin Jeyaseelan A., Madurai (IN); Kowshika K, Tiruppur (IN); Mohammed Mehtab Khan, Bengaluru (IN); Aman Desai, Bengaluru (IN); Sachin Chandrakant Gawali, Bangalore (IN); Amresh Kumar Yadav, Gopalganj (IN); Ninad Sitaram Phadnis, Pune (IN); Aman Shetty, Mysore (IN); Saket Raj, Patna (IN); S Monish Kumar, Chennai (IN); Pawan Kumar Yadav, Haryana (IN); Jeevan S D, Puttur Talluk (IN); Sanobernaz Reheman Ansari, West Jordan, UT (US); Praveen Nalawade, Bangaluru (IN); Sanskriti Jain, Shahdara (IN); Gunasekaran Karthikeyan, Thanjavur (IN); Jayakumar Jayabal, Bangalore (IN); Balaji Kannan, Chennai (IN); Ashfaq Hussain, Chennai (IN); Arun Karthik Senthil Murugan, Bangalore (IN)

(21) Appl. No.: 19/184,587

(22) Filed: Apr. 21, 2025

(51) Int. Cl. A61J 1/20

(52) U.S. Cl. CPC A61J 1/2058; A61J 1/201

(57) ABSTRACT

A fluid transfer system is provided that includes an infusion fluid container containing an infusion fluid therein and an infusion adapter for connection with the infusion fluid container. The infusion fluid container includes a port having a fluid barrier member therein. The infusion adapter includes a connection spike having a main spike portion and a puncturing point configured to engage the port, with the port positioned about the main spike portion and the puncturing point when engaged therewith, and a securing mechanism for securing the infusion fluid container and infusion adapter together. The securing mechanism secures the main spike portion within the port when engaged therewith, with the securing mechanism restricting vertical movement between the port and the main spike portion to prevent dislodging of the main spike portion from the port.

### BACKGROUND OF THE INVENTION

### Field of the Invention

The present disclosure relates generally to an infusion adapter and, more particularly, to a high-strength connector for securing a closed-system infusion adapter to an infusion fluid container for a drug transfer procedure.

### Description of Related Art

Intravenous therapy applications allow patients to receive infusion and medication treatment. For example, therapy may include the administration of medications by IV using intravenous and subcutaneous or hypodermis routes, i.e., into the bloodstream and under the skin. Examples of medical treatments that intravenous therapy applications may provide to a patient include antibiotics, pain management medications, cancer treatments, and similar medications.

Medications may be packaged as “pre-filled” devices, wherein a syringe assembly is pre-filled with medication prior to being packaged and delivered to a patient. “Pre-filled” devices eliminate the need for a user to fill the device prior to injection.

Certain drugs or medications are preferably provided in powder or dry form (such as a lyophilized form) and require reconstitution prior to administration. Lyophilized drugs, for example, typically are supplied in a freeze-dried form that needs to be mixed with a diluent to reconstitute the substance into a form that is suitable for injection. In addition, drugs may be provided as multipart systems that require mixing prior to administration. For example, one or more liquid components, such as flowable slurries, and one or more dry components, such as powdered or granular components, may be provided in separate containers that require mixing prior to administration.

A patient may be provided with an intravenous system that includes intravenous tubing and a connector that is adapted to receive an injector and/or syringe assembly containing a required medication. In this manner, when a treatment is needed, a patient or a medical practitioner is able to connect a syringe assembly to the connector and then inject a medication intravenously into the patient via the injector and/or syringe assembly, the connector, and the intravenous tubing.

When performing infusion, it is often necessary to inject a drug or other medical substance into the infusion fluid inside an infusion bag or other infusion fluid container. This is often done by means of penetrating a septum or other fluid barrier of an injection port on the infusion fluid container, and this may be done by an infusion adapter having a spike connector thereon, with a syringe in-turn connected to the infusion adapter that is filled with the medical fluid in question. In use of such an infusion adapter, the spike connector is pushed into the injection port on the infusion fluid container, thereby mechanically and fluidly connecting the infusion adapter and the infusion fluid container. However, it is recognized that the design of existing infusion adapters is such that engagement between the spike connector and the injection port does not provide a secure engagement that prevents dislodging of the spike connector from the injection port. In the event that the spike connector is dislodged from the injection port, medication may leak from the infusion fluid container, which may lead to hazardous drug exposure and/or costly medication waste.

Accordingly, it is desirable to provide a means for securely engaging an infusion adapter with an infusion fluid container, in order to prevent dislodging of the spike connector of the adapter from the injection port and potential medication leakage from the infusion fluid container.

### SUMMARY OF THE INVENTION

In accordance with an embodiment of the present invention, a fluid transfer system includes an infusion fluid container containing an infusion fluid therein, the infusion fluid container comprising a port having a fluid barrier member therein. The fluid transfer system also includes an infusion adapter for connection with the infusion fluid container, the infusion adapter having a main body and a connection spike positioned at a first end of the main body, the connection spike having a main spike portion and a puncturing point configured to engage the port, with the port positioned about the main spike portion when engaged therewith. The infusion adapter includes a securing mechanism configured to secure the main spike portion within the port when engaged therewith, with the securing mechanism restricting vertical movement between the port and the main spike portion to prevent dislodging of the main spike portion from the port.

In certain configurations, the securing mechanism includes a pair of adhesive strips secured to the main spike portion and provided on both sides thereof, with each of the adhesive strips configured as a flexible strip that is bendable to bring the adhesive strip into contact with an external surface of the port. The securing mechanism may include a pair of flexible fingers secured to the main body of the infusion adapter and positioned on opposing sides of the main spike portion, with each of the fingers including an adhesive layer thereon, and wherein the pair of flexible fingers are configured to bend to bring the adhesive layers thereon into contact with an external surface of the port. The securing mechanism may include a raised enclosure secured to the main body of the infusion adapter, with the raised enclosure positioned about a bottom region of the main spike portion such that a gap is present between the raised enclosure and the main spike portion to accommodate positioning of the port therein. An adhesive liner may be provided on an inner surface of the raised enclosure that bonds the port to the enclosure when the main spike portion is engaged with the port.

The securing mechanism may include a snap connector positioned about a bottom region of the main spike portion, with the snap connector including a base ring having an opening therein through which the main spike portion extends, and a plurality of fingers arranged circumferentially about the base ring, the plurality of fingers configured to flex and engage the port when the main spike portion is pushed into the port, with the plurality of fingers applying a radially inward-directed force against the port, to push the port against the spike portion.

The securing mechanism may include a clamp connector including a pair of rotatable grip tabs positioned on opposing sides of the main spike portion, each of the pair of rotatable grip tabs comprising a C-shaped grip member and a pair of arms that protrude out from the C-shaped grip member, with each of the pair of rotatable grip tabs rotatably joined to the main body of the adapter via a pair of ribs formed on the main body. The pair of rotatable grip tabs may be actuatable from an open position where the pair of grip tabs is separated from one another to an engaged position where the pair of grip tabs is brought into contact with each other such that the C-shaped grip members thereof apply a compression force against the port and the main spike portion engaged therein.

In certain configurations, each of the pair of rotatable grip tabs has a pair of arms including a hinge pin and a snap pin formed at a bottom end thereof, with the hinge pin engaging a pin hole formed in a respective rib of the pair of ribs to allow for rotation of the rotatable grip tab and the snap pin engaging a bump formed on an upper surface of a respective rib of the pair of ribs to provide for locking of the rotatable grip tab in the engaged position.

Optionally, the securing mechanism includes a clamp connector including a pair of rotatable friction tabs positioned on opposing sides of the main spike portion, each of the pair of rotatable friction tabs comprising a C-shaped grip member and an arm that protrudes out from the C-shaped grip member, with each of the pair of rotatable friction tabs rotatably joined to the main body of the adapter via a protrusion formed on the main body. The pair of rotatable friction tabs may be actuatable from an open position where the pair of friction tabs is separated from one another to an engaged position where the pair of friction tabs is brought into contact with each other such that the C-shaped grip members form an interference fit with the port and apply a compression force against the port and the main spike portion.

In certain configurations, the C-shaped grip member of one of the pair of friction clamps includes a pair of engagement tabs and the C-shaped grip member of the other of the pair of friction clamps includes a pair of receptacle, with the pair of engagement tabs and the pair or receptacles configured to mate with each other when the friction clamps are moved to the engaged position, to lock the pair of friction clamps together.

In other configurations, the securing mechanism includes a clamp connector having an annular port clamp having a slit formed therein that separates the annular port clamp into a pair of flexible arms that may deflect when a force is applied thereto. An adapter engagement member may be configured to secure the clamp connector to the infusion adapter, and a connecting arm may extend between the annular port clamp and the adapter engagement member. The port may be positioned about the main spike portion, and the annular port clamp may be pushed onto the engaged port and main spike portion at a location of the slit, with the engaged port and main spike portion retained within a receptacle defined by the annular port clamp. The annular port clamp may include a locking mechanism configured to secure a first flexible arm of the pair of flexible arms to a second flexible arm of the pair of flexible arms, thereby locking the annular port clamp in-place around the engaged port and main spike portion.

In certain configurations, the adapter engagement member includes an annular spike clamp having a slit formed therein that separates the annular spike clamp into a pair of flexible arms that may deflect when a force is applied thereto, and wherein the annular spike clamp may be pushed onto a bottom section of the main spike portion at a location of the slit, with the main spike portion retained within a receptacle defined by the annular spike clamp. The adapter engagement member includes a ring member configured to be press-fit onto the main spike portion to secure the clamp connector to the infusion adapter. The adapter engagement member may include a bottom end of the connecting arm, with the bottom end formed integrally with the main body of the infusion adapter.

Optionally, the securing mechanism may include a clamp connector including a pair of U-shaped clips configured to attach to the main body of the infusion adapter, each of the pair of U-shaped clips may include an upper arm and a lower arm, with each of the pair of U-shaped clips attached to the main body such that the upper arm is positioned above a stop of the main body and the U-shaped clip wraps around a side edge of the main body such that the lower arm is positioned below the stop. A clamp member includes an annular port clamp having a slit formed therein that separates the annular port clamp into a pair of flexible arms that may deflect when a force is applied thereto. A pair of connecting arms may be integrally formed with the annular port clamp and positioned on opposing sides thereof, the pair of connecting arms extending away from the annular port clamp and each including an opening formed at a bottom end thereof, with the upper arm of each of the pair of U-shaped clips inserted into the opening, such that the clamp member is rotatably coupled to the pair of U-shaped clips and is movable from a disengaged position where the annular port clamp is not clamped onto the engaged port and main spike portion to an engaged position where the annular port clamp is clamped onto the engaged port and main spike portion. With the port positioned about the main spike portion, the clamp member may be rotated and the annular port clamp pushed onto the engaged port and main spike portion at a location of the slit, with the engaged port and main spike portion retained within a receptacle defined by the annular port clamp.

In certain configurations, the upper arm of each of the U-shaped clips includes a first tooth formed thereon and each arm of the pair of connecting arms includes a second tooth therein extending into the opening, with the first tooth and the second tooth engaging each other when the clamp member is in the engaged position, so as to lock the clamp member in the engaged position. The securing mechanism may include a securing latch including a side arm having a first end joined to the main body of the infusion adapter and a free second end. The securing mechanism may include a C-shaped collar formed at the free second end of the second end, with the C-shaped collar sized and configured to clamp onto the engaged port and main spike portion. The securing mechanism may also include a push tab formed on the side arm at a location between the first and second ends, with the push tab configured to be engaged by a user to actuate the side arm from a disengaged position where the C-shaped collar is separated from the engaged port and main spike portion to an engaged position where the C-shaped collar is secured to the engaged port and main spike portion.

The securing mechanism includes a securing latch including a pair of rotatable arms connected to the main body of the infusion adapter on opposing sides of the main spike portion and rotatable from a disengaged position to an engaged position, where each of the pair of rotatable arms includes a first linear portion rotatably connected to the main body, a second linear portion forming a free end of the arm and in parallel with the first linear portion, and a transition portion connecting the first linear portion to the second linear portion. The transition portion offsetting the second linear portion from the first linear portion such that, when the securing latch is in the engaged position, the second linear portion is inset radially inward from the first linear portion relative to the main spike portion. With the securing latch in the engaged position, the pair of rotatable arms contact the port and conform to an outer surface thereof, with the transition portion aligned with a collar of the port such that the radially inset second portion is positioned over the collar.

In certain configurations, the securing mechanism includes a bellows including an extendable sleeve positioned about the main spike portion and that is actuatable from a shortened configuration to an extended configuration. With the extendable sleeve in the shortened configuration, the main spike portion may engage the port, and with the extendable sleeve in the extended configuration, the extendable sleeve extends over the engaged port and main spike portion.

The fluid transfer system may also include a tightening member positionable over the bellows when the extendable sleeve is in the extended configuration, with the tightening member securing the bellows to the engaged port and main spike portion. The securing mechanism may include a male luer connector having a rotating collar positioned on the main spike portion, proximate the puncturing point, with the rotating collar rotatable relative to the main spike portion. The port may include a female luer connector having a luer lug positioned at an end of the port, with a threaded inner surface of the rotating collar configured to be brought into threaded engagement with a threaded outer surface of the luer lug when the main spike portion is engaged with the port.

In certain configurations, the securing mechanism includes a pin holder connector having a pair of support protrusions formed integrally with the main body of the infusion adapter and each including a hook at a free end thereof, the pair of support protrusions positioned on opposing sides of the main spike portion and extending upward a partial length of the main spike portion. A movable inner cylinder may be positioned about the main spike portion, at a bottom end thereof, and movable relative to the main spike portion and the pair of support protrusions, with movement of the movable inner cylinder restricted by the hooks of the pair of support protrusions. The movable inner cylinder may include a tube-shaped main body including notches formed therein, and grippers formed on opposing sides of the tube-shaped main body and extending radially outward therefrom. The grippers may be configured to be engaged by a user to facilitate movement of the movable inner cylinder relative to the main spike portion. A plurality of pins may be formed on the tube-shaped main body, along a circumferential edge thereof, with each of the plurality of pins extending radially inward. With the port positioned about the main spike portion, the movable inner cylinder is configured to move from an initial position where the movable inner cylinder does not engage the port to an engaged position where the movable inner cylinder fully engages the port, and with the movable inner cylinder in the engaged position, the movable inner cylinder is retained between a spike collar of the main spike portion and the hooks of the support protrusions.

In certain configurations, the notches may include a pair of notches formed at a bottom end of the tube-shaped main body, on opposing sides thereof. The plurality of pins may include a pair of upper pins provided on a top end of the tube-shaped main body, along the circumferential edge thereof and on opposing sides of the tube-shaped main body and angled to extend upward from the top end and radially inward. A pair of lower pins may be provided within the pair of notches, along the circumferential edge of the tube-shaped main body and on opposing sides of the tube-shaped main body, with the lower pins angled to extend downward and radially inward. With the movable inner cylinder in the engaged position, the upper pins engage the hooks and the lower pins engage the spike collar.

In certain configurations, the notches include a pair of upper notches formed at a top end of the tube-shaped main body, on opposing sides thereof and a plurality of lower notches formed at a bottom end of the tube-shaped main body and spaced circumferentially thereabout. The plurality of pins may include a pair of upper pins provided within the pair of upper notches, along the circumferential edge of the tube-shaped main body and on opposing sides of the tube-shaped main body, with the pair of upper pins angled to extend upward and radially inward. With the movable inner cylinder in the engaged position, the upper pins engage the hooks and a bottom edge of the tube-shaped main body engages the spike collar. Optionally, the securing mechanism may include a pin holder connector including an outer cylinder attached to the port, an inner cylinder attached to the main spike portion, and V-shaped pins attached on both sides of the port, with one end of each V-shaped pin attached to the outer cylinder and another end of each V-shaped pin attached to the inner cylinder. The V-shaped pins may be configured to pinch the port onto the main spike portion responsive to a pulling force being applied to the infusion adapter.

In certain configurations, the securing mechanism includes a hinged clip connector joined with the main body of the infusion adapter, the hinged clip connector including a first clip arm and a second clip arm positioned on opposing sides of the main spike portion. Each of the first clip arm and the second clip arm may include an engagement portion extending up past a stop of the main body and up along a partial length of the main spike portion, and including a hook or knurling at a far end thereof configured to mate with a collar of the port, and an actuation portion joined with the engagement portion at an end thereof opposite the hook or knurling, the actuation portion comprising a finger press. Responsive to a pinching force being applied to the finger presses of the first clip arm and the second clip arm, the first clip arm and the second clip arm are caused to separate further, allowing the main spike portion to be pressed into and engaged with the port. Upon engaging of the main spike portion with the port and releasing of the finger presses of the first clip arm and the second clip arm, the first clip arm and the second clip arm move back to an initial closed position, where the hook or knurling engages the collar of the port.

In accordance with an embodiment of the present invention, a method of connecting and securing an infusion adapter with an infusion fluid container includes providing an infusion adapter having a main body, a connection spike positioned at a first end of the main body, the connection spike having a main spike portion and a puncturing point configured to engage a port of the infusion fluid container, and a securing mechanism. The method further includes pushing the main spike portion into a port of the infusion fluid container such that the puncturing point pierces a fluid barrier member of the infusion fluid container, and actuating the securing mechanism to secure the main spike portion within the port, with the securing mechanism restricting vertical movement between the port and the main spike portion to prevent dislodging of the main spike portion from the port.

In certain configurations, the method further includes providing the infusion adapter with the securing mechanism integrally formed with the main body or the main spike portion. Providing the infusion adapter may further include pre-fixing the securing mechanism to the main body or the main spike portion prior to pushing the main spike portion into the port. Optionally, actuating the securing mechanism comprises manually actuating the securing mechanism subsequent to pushing the main spike portion into the port. Optionally, actuating the securing mechanism includes mechanically actuating the securing mechanism as the main spike portion is pushed into the port.

### BRIEF DESCRIPTION OF THE DRAWINGS

FIG. 1 is a perspective view of an infusion adapter with which aspects of the disclosure may be implemented;

FIG. 2 is a right-side view of the infusion adapter of FIG. 1;

FIG. 3 is a bottom view of the infusion adapter of FIG. 1;

FIG. 4 s a cross-sectional view along line 4-4 shown in FIG. 3;

FIG. 5 is a front view of the infusion adapter of FIG. 1;

FIG. 6 is a rear view of the infusion adapter of FIG. 1;

FIG. 7 is a cross-sectional view along line 4-4 shown in FIG. 3, showing the infusion adapter inserted into a port of an infusion fluid container;

FIG. 8 is a perspective view of another infusion adapter with which aspects of the disclosure may be implemented;

FIG. 9 is a right-side view of another infusion adapter with which aspects of the disclosure may be implemented;

FIG. 10 is a side view of an infusion adapter including an adhesive-based securing mechanism of for securing a port of an infusion fluid container together with a spike portion of the infusion adapter, according to an aspect of the disclosure, with the adhesive-based securing mechanism shown in a pre-use configuration;

FIG. 11 is a perspective view of the infusion adapter and adhesive-based securing mechanism of FIG. 10, with the adhesive-based securing mechanism shown in a use configuration;

FIG. 12 is a perspective view of an infusion fluid container and an infusion adapter, with the infusion adapter including the adhesive-based securing mechanism of FIG. 10;

FIG. 13 is a top perspective view of an infusion adapter including an adhesive-based securing mechanism, according to another aspect of the disclosure;

FIG. 14 is a perspective view of an infusion adapter including an adhesive-based securing mechanism, according to another aspect of the disclosure, prior to engaging of a spike portion of the infusion adapter with a port of an infusion fluid container;

FIG. 15 is a perspective view of the infusion adapter and adhesive-based securing mechanism of FIG. 14 after engaging of the spike portion of the infusion adapter with the port of the infusion fluid container;

FIG. 16 is a perspective view of the infusion adapter and adhesive-based securing mechanism of FIG. 14 after engaging of the spike portion of the infusion adapter with the port of the infusion fluid container, and showing adhesive securing the spike portion and port together;

FIG. 17 is a perspective view of an infusion adapter with an integrated securing mechanism, according to another aspect of the disclosure;

FIG. 18 is a perspective view of an infusion adapter with an integrated securing mechanism, according to another aspect of the disclosure;

FIG. 19 is a perspective view of an infusion adapter with an integrated securing mechanism, according to another aspect of the disclosure;

FIG. 20 is a perspective view of an infusion adapter with an integrated securing mechanism, according to another aspect of the disclosure;

FIG. 21 is a perspective view of the infusion adapter of FIG. 20 connected to an infusion fluid container;

FIG. 22 is a perspective view of the infusion adapter of FIG. 19 connected to an infusion fluid container;

FIG. 23 is a perspective view of an infusion adapter with attached securing mechanism, according to another aspect of the disclosure, prior to engaging of a spike portion of the infusion adapter with a port of an infusion fluid container;

FIG. 24 is a perspective view of the infusion adapter of FIG. 23 after engaging of the spike portion of the infusion adapter with the port of the infusion fluid container;

FIG. 25 is a perspective view of an infusion adapter with attached securing mechanism, according to another aspect of the disclosure, prior to engaging of a spike portion of the infusion adapter with a port of an infusion fluid container;

FIG. 26 is a perspective view of the infusion adapter of FIG. 25 after engaging of the spike portion of the infusion adapter with the port of the infusion fluid container;

FIG. 27 is a perspective view of a clamp connector, according to another aspect of the disclosure;

FIG. 28 is a perspective view of the clamp connector of FIG. 27 shown secured to an infusion adapter;

FIG. 29 is a perspective view of the clamp connector of FIG. 27 shown securing an infusion fluid container port to the infusion adapter;

FIG. 30 is a perspective view of a clamp connector, according to another aspect of the disclosure;

FIG. 31 is a perspective view of the clamp connector of FIG. 30 shown secured to an infusion adapter;

FIG. 32 is a perspective view of the clamp connector of FIG. 30 shown securing an infusion fluid container port to the infusion adapter;

FIG. 33 is a perspective view of an infusion adapter with an integrated clamp connector, according to another aspect of the disclosure;

FIG. 34 is a perspective view of the infusion adapter of FIG. 33 shown with the clamp connector securing an infusion fluid container port to the infusion adapter;

FIG. 35 is a perspective view of an infusion adapter with an integrated clamp connector, according to another aspect of the disclosure;

FIG. 36 is a perspective view of the infusion adapter of FIG. 35 shown with the clamp connector securing an infusion fluid container port to the infusion adapter;

FIG. 37 is a perspective view of an infusion adapter with a securing latch, according to another aspect of the disclosure;

FIG. 38 is a perspective view of an infusion adapter with a securing latch, according to another aspect of the disclosure, with the securing latch shown in an open configuration;

FIG. 39 is a perspective view of the infusion adapter of FIG. 38, with the securing latch shown in a closed configuration and securing an infusion fluid container port to the infusion adapter;

FIG. 40 is a perspective view of an infusion adapter with a bellows-type securing mechanism provided thereon, according to another aspect of the disclosure;

FIG. 41 is a perspective view of the infusion adapter and bellows-type securing mechanism of FIG. 40, securing an infusion fluid container port to the infusion adapter;

FIG. 42 is a perspective view of an infusion adapter and infusion fluid container with a luer connection securing mechanism, according to another aspect of the disclosure, prior to engaging of a spike portion of the infusion adapter with a port of the infusion fluid container;

FIG. 43 is a perspective view of the infusion adapter and infusion fluid container of FIG. 42, after engaging of the spike portion of the infusion adapter with the port of the infusion fluid container;

FIG. 44 is a perspective view of an infusion adapter with an integrated pin holder connector, according to another aspect of the disclosure;

FIG. 45 is a perspective view of a movable inner cylinder included in the infusion adapter of FIG. 44;

FIG. 46 is a perspective view of the infusion adapter of FIG. 44, showing the integrated pin holder connector connecting an infusion fluid container port to the infusion adapter;

FIG. 47 is a perspective view of an infusion adapter with an integrated pin holder connector, according to another aspect of the disclosure;

FIG. 48 is a perspective view of a movable inner cylinder included in the infusion adapter of FIG. 47;

FIG. 49 is a perspective view of the infusion adapter of FIG. 44, showing the integrated pin holder connector connecting an infusion fluid container port to the infusion adapter;

FIG. 50 is a side cross-sectional view of a pin holder connector for securing an infusion adapter with an infusion fluid container, with the pin holder connector in a disengaged configuration;

FIG. 51 is a side cross-sectional view of the pin holder connector of FIG. 50, with the pin holder connector in a disengaged configuration;

FIG. 52 is a perspective view of an infusion adapter with an integrated hinged clip connector, according to another aspect of the disclosure;

FIG. 53 is a perspective view of an infusion adapter with an integrated hinged clip connector, according to another aspect of the disclosure;

FIG. 54 is a perspective view of the infusion adapter of FIG. 52 shown with the hinged clip connector securing an infusion fluid container port to the infusion adapter; and

FIG. 55 is a perspective view of an infusion adapter with an integrated hinged clip connector, according to another aspect of the disclosure.

### DESCRIPTION OF THE INVENTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

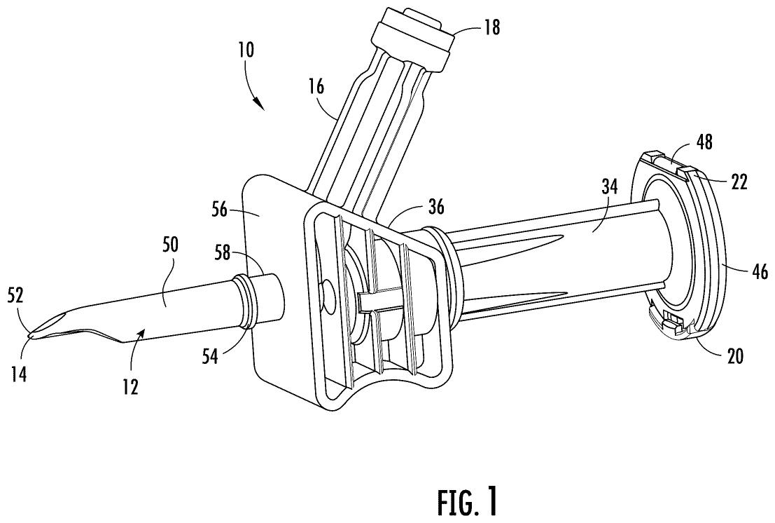

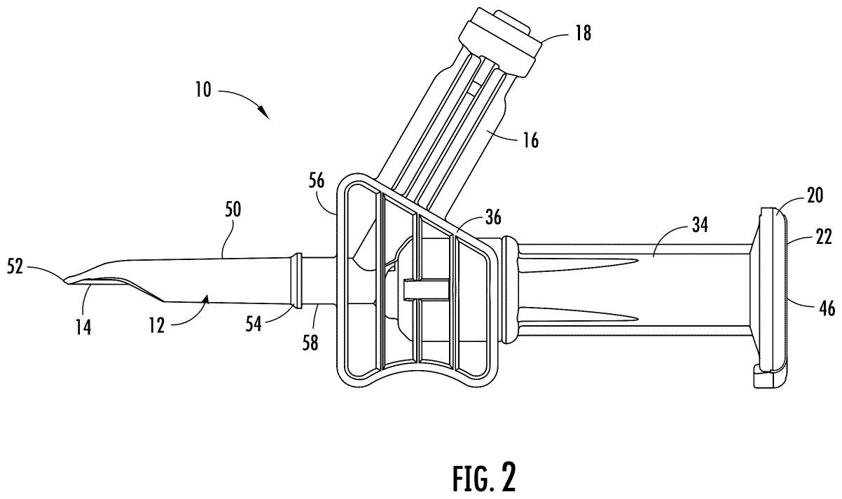

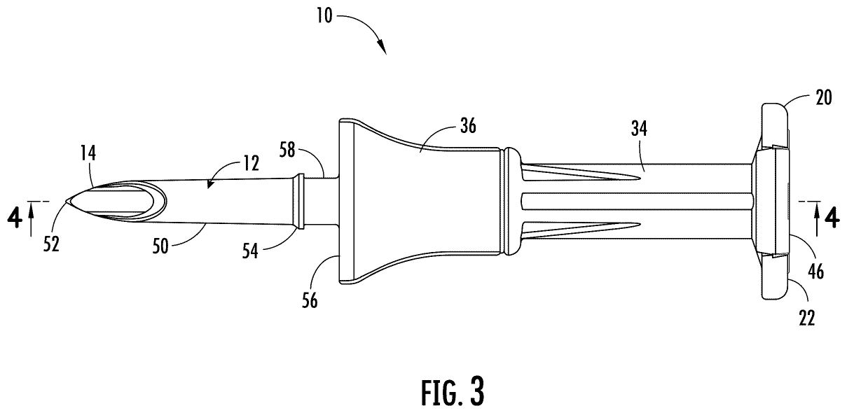

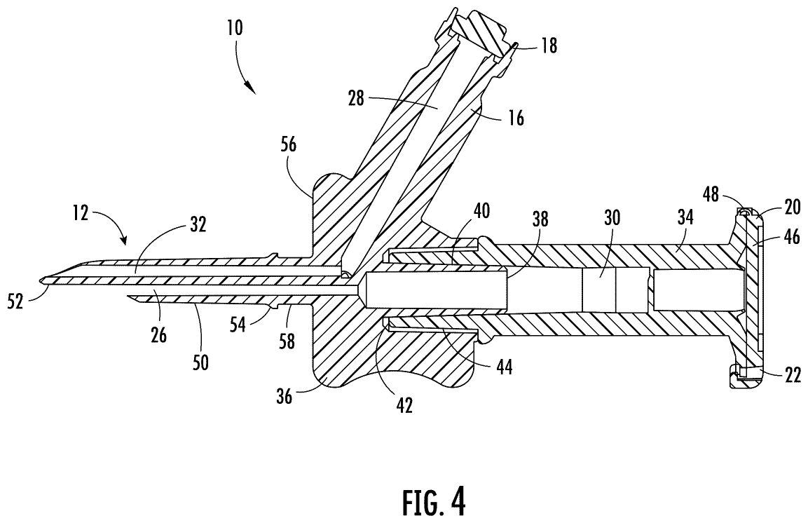

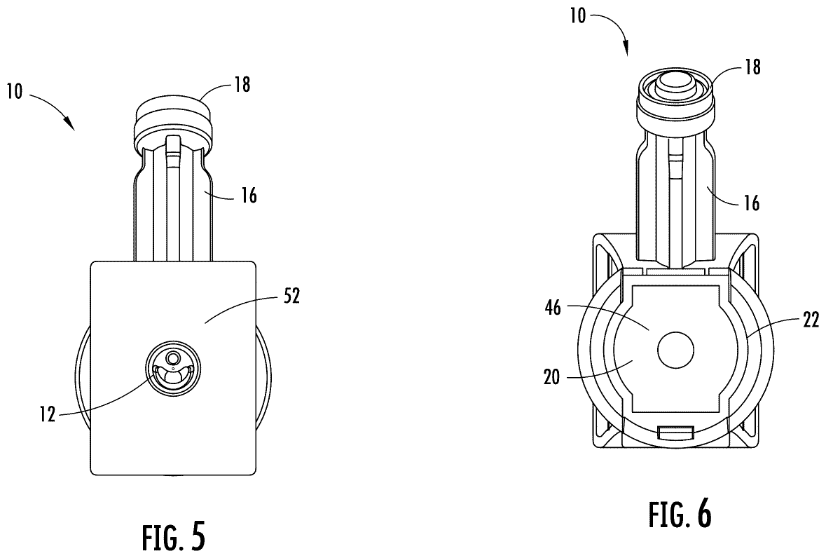

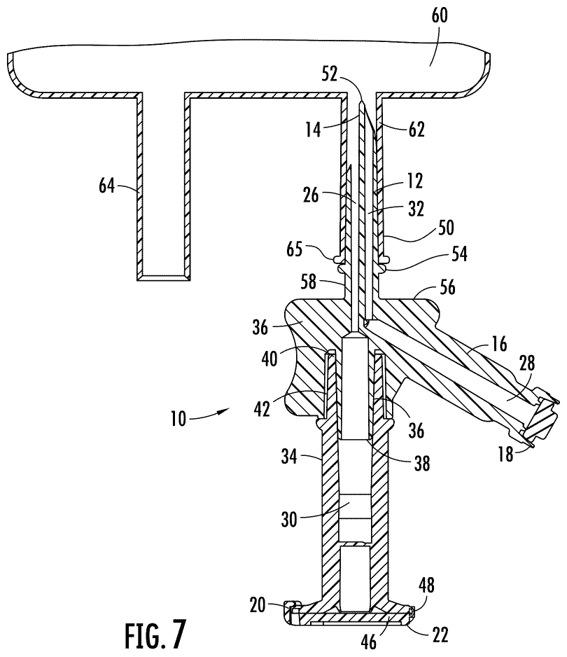

Referring to FIGS. 1-7, shown is a non-limiting embodiment of an infusion adapter 10 used in/with the closed preparation of a drug. In one embodiment, infusion adapter 10 may be structured similarly to a PhaSeal™ adapter which is compatible with a Becton Dickinson (“BD”) PhaSeal™ System available from Becton, Dickinson and Company of Franklin Lakes, N.J. The infusion adapter 10 thus includes a connection portion 12 located at a first end 14, a first port 16 located at a first port end 18, and a second port 20 located at a second port end 22. Connection portion 12 includes a fluid channel 26 and a fluid channel 32, although only a single channel arrangement may also be utilized. First port 16 includes a first port fluid channel 28 and second port 20 includes a second port fluid channel 30. As shown more clearly in FIGS. 4 and 7, the fluid channel 32 of connection portion 12 is in fluid communication with first port fluid channel 28 of first port 16 such that a fluid may flow into infusion adapter 10 at first port 16, travel through first port fluid channel 28 to fluid channel 32 of connection portion 12 and out first end 14 of infusion adapter 10. The fluid channel 26 of connection portion 12 is in fluid communication with second port fluid channel 30 of second port 20 such that a fluid may flow into infusion adapter 10 at first end 14 of connection portion 12, travel through fluid channel 26 to second port fluid channel 30 and out second port 20 of infusion adapter 10.

As shown in FIGS. 1-7, in one embodiment, infusion adapter 10 may comprise a generally Y-shape. Further, it is contemplated that infusion adapter 10 may be made available in a variety of shapes and sizes as long as first port 16 is spaced a distance from second port 20 so that first port 16 may be connected to a syringe assembly containing a medication fluid and second port 20 may be connected to an intravenous line that is adapted for connection to a bloodstream of a patient as will be described in more detail below. For example, in another embodiment, infusion adapter 10 may comprise a generally T-shape.

Referring to FIG. 4, in one embodiment, infusion adapter 10 may include an intravenous line connector 34 that is removably connectable to a main body 36 of infusion adapter 10. In such an embodiment, main body 36 includes an intravenous line connector receiving end 38 having a first connection portion 40. Additionally, intravenous line connector 34 includes a main body receiving end 42 having a second connection portion 44. Intravenous line connector 34 includes an end cap 46 that is pivotable via a hinge portion 48 between an open position and a closed position.

Intravenous line connector 34 may be connected to main body 36 by positioning main body receiving end 42 of intravenous line connector 34 into engagement with intravenous line connector receiving end 38 of main body 36. In one embodiment, intravenous line connector 34 may be secured to main body 36 by positioning second connection portion 44 of intravenous line connector 34 into engagement with first connection portion 40 of main body 36, and threadingly engaging first connection portion 40 and second connection portion 44. In other embodiments, second connection portion 44 of intravenous line connector 34 may be secured to first connection portion 40 of main body 36 using a press-fit, locking tapers, interference fit, snap-fit, ball detent, locking tabs, spring loaded locking mechanism, latch, adhesive, or other similar mechanism. In this manner, intravenous line connector 34 is locked to main body 36, i.e., significant relative movement between intravenous line connector 34 and main body 36 is prevented. In alternate embodiments, intravenous line connector 34 and main body 36 may be integrally formed.

According to aspects of the disclosure, connection portion 12 of infusion adapter 10 includes an elongated cylindrical main spike portion 50, a puncturing point 52 disposed adjacent first end 14, and an annular spike collar 54 provided on main spike portion opposite from puncturing point 52.

The fluid channels 26, 32 extend through a length of the main spike portion 50 extending from the puncturing point 52 at first end 14 to a junction/connection with first port fluid channel 28 and/or second port fluid channel 30.

The puncturing point 52 comprises a sharpened point or end that is configured to engage and pierce into an infusion fluid container. In one example, the puncturing point 52 is configured to be inserted/spiked to an IV bag through a rubber bung in an IV bag port.

The spike collar 54 extends radially outward from the main spike portion 50 and is positioned adjacent to a stop 56 defined by the main body 36 of the infusion adapter 10. A space 58 is provided between the spike collar 54 and the stop 56. In some embodiments, a plurality of reinforcement ribs (not shown) may be formed about main spike portion 50 in the space 58 between the spike collar 54 and the stop 56 that may be spaced circumferentially about main spike portion 50 and extend radially outward therefrom to provide a connection of increased strength between the connection portion 12 and the main body 36.

As previously discussed, intravenous therapy applications allow patients to receive infusion and medication treatment. For example, therapy may include the administration of medications by IV using intravenous and subcutaneous or hypodermis routes, i.e., into the bloodstream and under the skin. Examples of medical treatments that intravenous therapy applications may provide to a patient include antibiotics, pain management medications, cancer treatments, and similar medications.

Referring to FIG. 7, infusion adapter 10 is shown connected to an infusion fluid container 60, which may comprise an IV bag according to one embodiment. More specifically, the connection portion 12 of the infusion adapter 10 is inserted into a first or injection port 62 of the infusion fluid container 60. In some embodiments, the infusion fluid container 60 may also include a second port 64. In some embodiments, the injection port 62 of infusion fluid container 60 may include an annular port collar 65 thereon, with the annular port collar 65 positioned toward an end of the port 62, such that it may be brought adjacent to spike collar 54 upon engagement of the main spike portion 50 with the port 62.

With infusion adapter 10 securely connected to port 62 of infusion fluid container 60, a patient or a medical practitioner is able to connect a syringe assembly (not shown) to first port 16 of infusion adapter 10. The first port 16 may be compatible with any suitable connection arrangement and any suitable syringe adapter. With the syringe assembly connected to first port 16, a medication fluid contained in the syringe assembly can be injected into the infusion fluid container 60 via infusion adapter 10. The syringe assembly may then be disconnected from infusion adapter 10 and the infusion fluid container 60 may then be sent to nursing and is ready to be administered to a patient. For example, an intravenous line or intravenous tubing may be connected to second port 20 of infusion adapter 10 with the other end of the intravenous tubing connected to a bloodstream of a patient. In this manner, a medication may be administered to the patient intravenously.

While the infusion adapter 10 shown in FIGS. 1-7 is configured as a Y-shaped adapter that includes an intravenous line connector 34 for connection with an intravenous line/tube, it is recognized that infusion adapters could be provided having different configurations, according to further aspects of the disclosure.

Referring to FIG. 8, an infusion adapter 10A, according to a second aspect, includes a direct connection with intravenous tubing 66 rather than providing the intravenous line connector 34 shown in FIGS. 1-7.

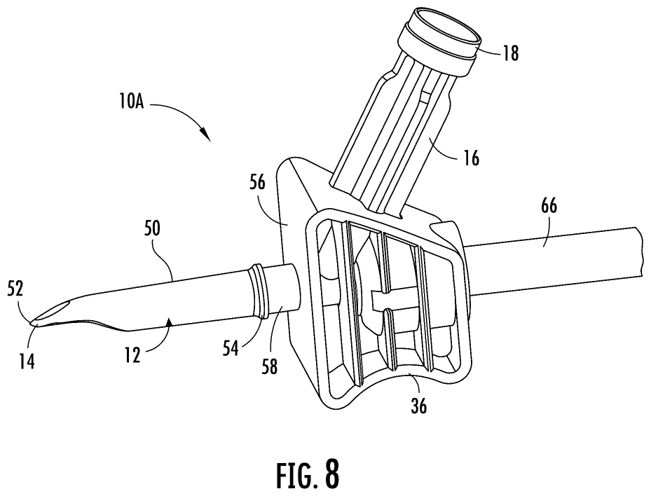

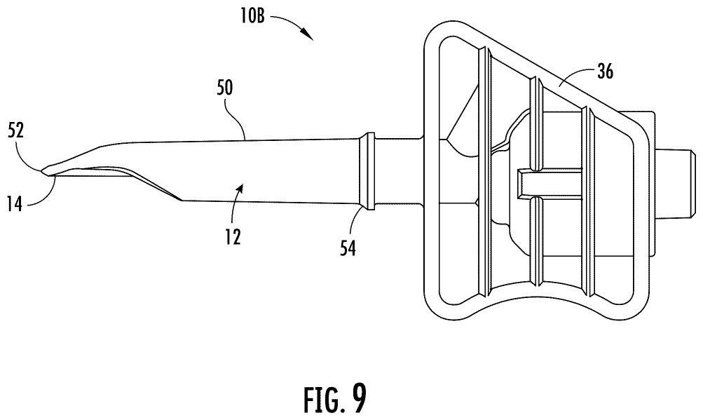

Referring to FIG. 9, an infusion adapter 10B, according to a third aspect, includes a direct connection for intravenous tubing and does not include the first port 16 shown in FIGS. 1-7.

In any of the infusion adapters 10, 10A, 10B shown in FIGS. 1-9, it is recognized that it is desirable for the connection portion 12 to be securely retained within the port 62 of the infusion fluid container 60, in order to prevent inadvertent and accidental dislodging of the connection portion 12 out from the port 62 during a drug transfer procedure.

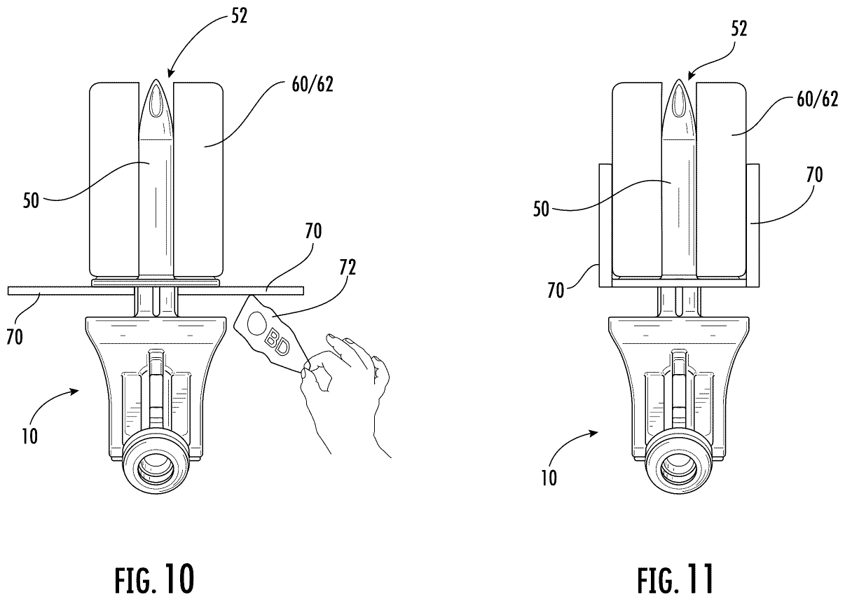

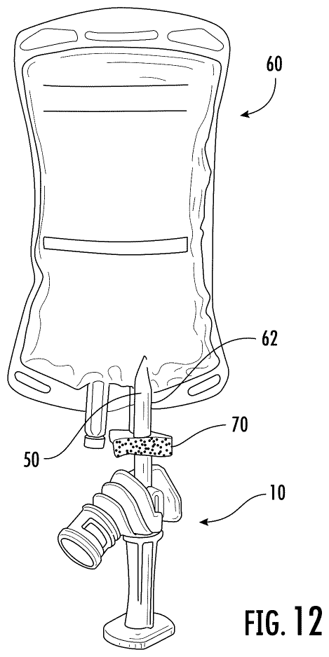

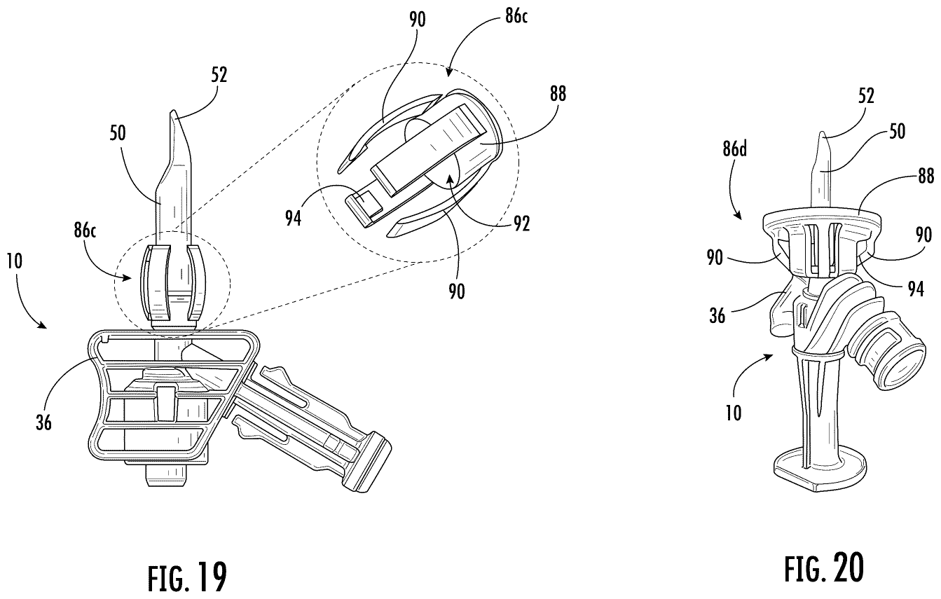

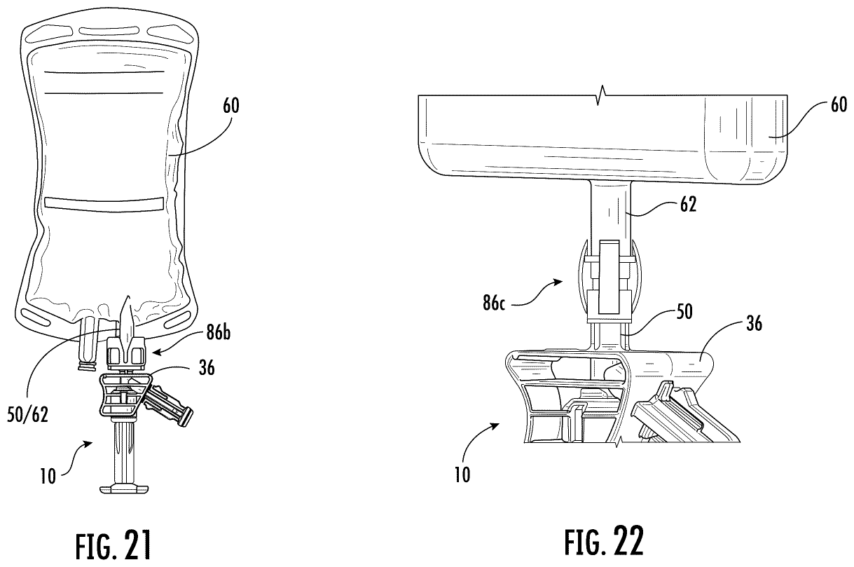

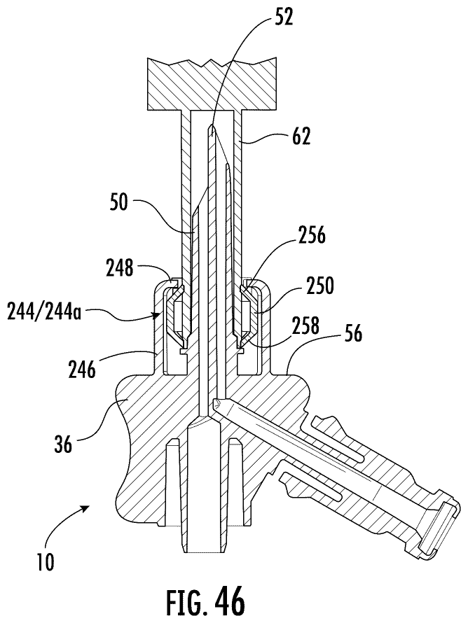

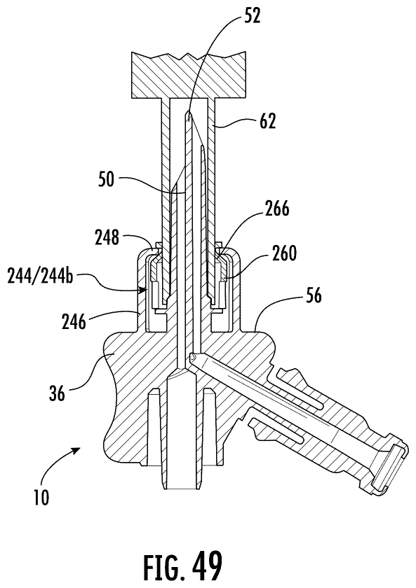

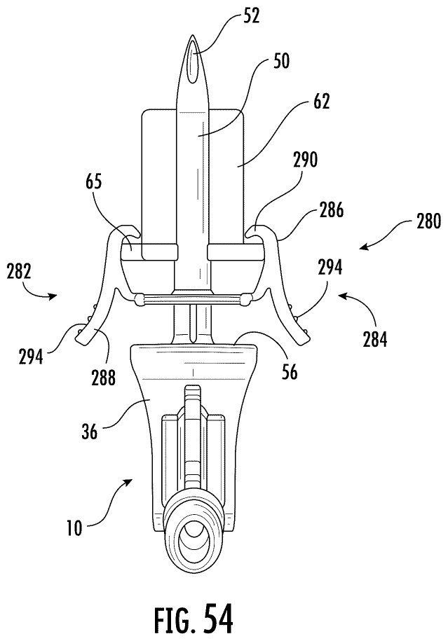

According to aspects of the disclosure, a securing mechanism may be provided to maintain engagement of the connection portion 12 with the injection port 62, so as to prevent leaking of medication from the infusion fluid container 60 that could lead to hazardous drug exposure and/or costly medication waste. Embodiments of various securing mechanisms are provided in FIGS. 10-55 and are described in more detail here below.

Referring to FIGS. 10-16, various adhesive-based securing mechanisms that may be included on the adapter are illustrated, according to embodiments of the disclosure. The adhesive-based securing mechanisms may include an adhesive layer, pad, or strips that may be deployed on the spike portion 50 and that will stick to the infusion fluid container 60 (i.e., to port 62) once external pressure is applied.

In FIGS. 10-12, an infusion adapter 10 is illustrated that includes a securing mechanism in the form of two rectangular adhesive strips 70 that are provided on both sides of the spike portion 50 and that are secured thereto. Each of the strips 70 includes an adhesive layer that is initially covered by a peel-off seal 72. Each of the strips 70 is configured as a flexible strip that can be folded after puncturing of the infusion fluid container 60 with the spike portion 50 of adapter 10. That is, when the puncturing point 52 is pierced into the infusion fluid container 60, the peel-off foil 72 may be removed from the strips 70. As the spike portion 50 is then inserted into the port 62, the strips 70 can be bent upwards. By bending the strips 70 in this manner, the adhesive layer thereon can be brought into contact with an external surface of the port 62, with an external pressure being applied to the strips 70 to bond the strips 70 to the port 62. Accordingly, the strips 70 function to increase a securing force between the connection portion 12 and the port 62, such that dislodging of the spike portion 50 from the port 62 can be prevented.

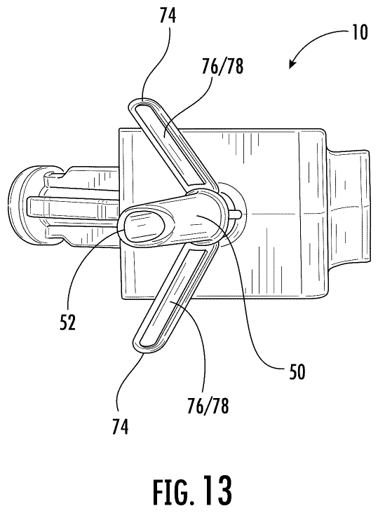

In FIG. 13, an infusion adapter 10 is illustrated that includes a securing mechanism in the form of a pair of flexible/rotatable fingers 74 that are provided on opposing sides of the spike portion 50 and that are secured to the main body 36 of the infusion adapter 10. Each of the fingers 74 includes an adhesive strip 76 thereon having an adhesive layer this is initially covered by a layer of adhesive liner 78, with the adhesive liner 78 being a silicone release liner according to one embodiment. When the puncturing point 52 is pierced into the infusion fluid container 60 and spike portion 50 is inserted into the port 62, the adhesive liner 78 is removed from the adhesive strips 76, and the fingers 74 are then rotated/bent upwardly to bring the adhesive strips 76 into contact with an external surface of the port 62. Pressure may then be applied to a backside of the fingers 74 to create a strong bond between the adhesive strips 76 and the port 62. Accordingly, the fingers 74 and adhesive strips 76 thereon function to increase a securing force between the spike portion 50 and the port 62, such that dislodging of the spike portion 50 and the port 62 can be prevented.

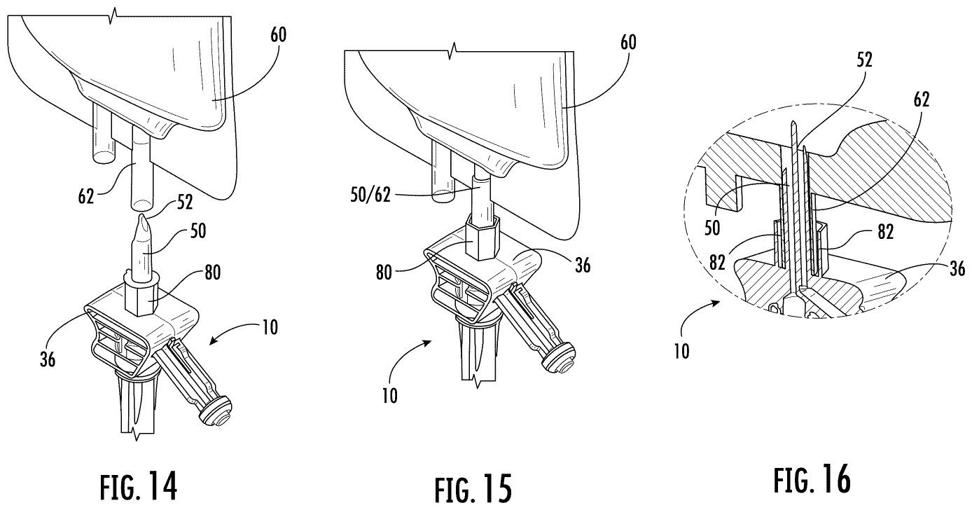

In FIGS. 14-16, an infusion adapter 10 is illustrated that includes a securing mechanism in the form of a raised platform or enclosure 80 that surrounds a bottom end of the spike portion 50 and that is secured to the main body 36 of the infusion adapter 10. The raised enclosure 80 may have a circular shape or hexagonal shape, according to embodiments, with the raised enclosure 80 positioned about spike portion 50 such that a gap is present between the enclosure 80 and the spike portion 50—with the gap sized to accommodate positioning of the port 62 of infusion fluid container 60 therein when the puncturing point 52 is pierced into the infusion fluid container 60. An adhesive liner 82 is provided on an inner surface of the raised enclosure 80, with a peel-off lid 84 positioned at a top end of the raised enclosure 80 that-when attached, seals off the interior of the raised enclosure 80 and prevents the adhesive liner 82 from drying out. When it is desired to engage the adapter 10 with the infusion fluid container 60, the peel-off lid 84 is removed and the adapter 10 is engaged with the infusion fluid container 60 by pushing puncturing point 52 into the infusion fluid container 60. As the spike portion 50 is pushed into the port 62, the port 62 is moved into the gap between spike portion 50 and raised enclosure 80 and brought into contact with the adhesive liner 82. Pressure may then be applied to the enclosure 80 to create a strong bond between the adhesive liner 82 and the port 62. Accordingly, the raised enclosure 80 and adhesive liner 82 thereon function to increase a securing force between the spike portion 50 and the port 62, such that dislodging of the spike portion 50 and the port 62 can be prevented.

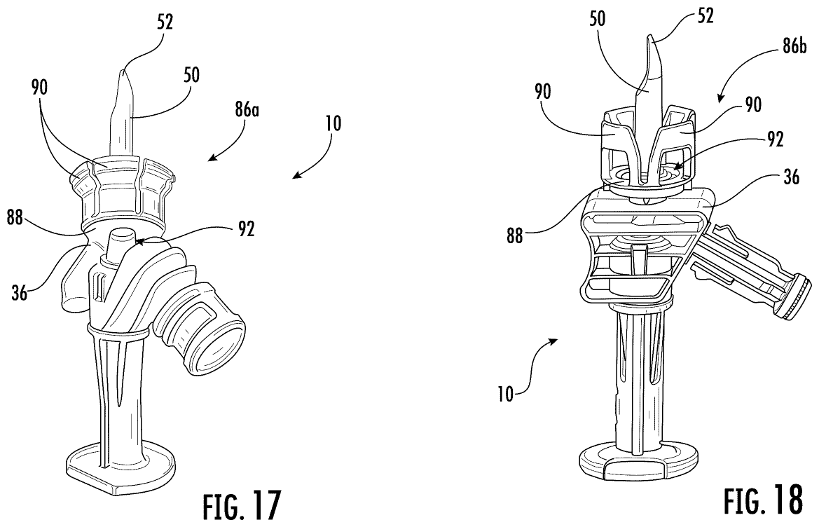

Referring now to FIGS. 17-22, various embodiments of a flexible, snap-type securing mechanism or “snap connector” 86a, 86b, 86c, 86d that may be included on the infusion adapter 10 are illustrated, according to embodiments of the disclosure. In some embodiments, the snap connector 86a, 86b, 86c, 86d may be integrally formed with the infusion adapter 10 (i.e., with main body 36), while in other embodiments the snap connector may be affixed to the infusion adapter 10, such as via a twist-type or snap-fit connection thereto.

In each of the embodiments of FIGS. 17-20, the snap connector 86a, 86b, 86c, 86d may be generally characterized as including a base ring 88 and a plurality of fingers 90 that are configured to flex and engage the injection port 62 when the spike portion 50 is pushed into the port 62, so as to secure the adapter 10 to the infusion fluid container 60. The fingers 90 are arranged circumferentially about the spike portion 50 of the adapter 10 and are spaced apart radially from the spike portion 50, such that space is provided for the port 62 to be slid/positioned over the spike portion 50 and such that the fingers 90 may engage an outer surface of the injection port 62.

In each of the embodiments of FIGS. 17-19, the base ring 88 is positioned at a first end of the snap connector 86a, 86b, 86c, at a location adjacent to the spike collar 54 of spike portion 50, with the fingers 90 then extending upward from the base ring 88 and away from the main body 36 of adapter 10. In the embodiment of FIG. 20, the base ring 88 is positioned at a second end of the snap connector 86d and at a location more toward the puncturing point 52 of spike portion 50, with the fingers 90 then extending downward from the base ring 88 and back toward the main body 36 of adapter 10.

In some embodiments, and where the snap connector 86a, 86b, 86c is affixed to the adapter 10, base ring 88 may be configured to include a central opening 92 therein via which the snap connector 86a, 86b, 86c may be secured to the adapter 10. The central opening 92 may be sized to allow for passage of spike portion 50 therethrough without interference but may engage with the spike collar 54 via a press-fit connection. That is, in order to secure the snap connector 86a, 86b, 86c to adapter 10, the snap connector 86a, 86b, 86c may be slid down over spike portion 50 and, upon snap connector 86a, 86b, 86c reaching spike collar 54, the snap connector 86a, 86b, 86c is forced downward and past spike collar 54, with the central opening 92 flexing/deforming to provide for passage of the spike collar 54 therethrough. Upon the snap connector 86a, 86b, 86c being moved to its secured position, the spike collar 54 then prevents the snap connector 86a, 86b, 86c from being disconnected from adapter 10.

For each of the snap connectors 86a, 86b, 86c, 86d shown in FIGS. 17-20, the fingers 90 are arranged circumferentially about the base ring 88. The number of fingers 90 may vary, but in exemplary embodiments may range from four to six fingers 90, as non-limiting examples. In some embodiments, a free end of each finger 90 (opposite of where the finger 90 is joined to base ring 88) may include a hook or catch 94 formed thereon that is configured to securely engage an outer surface of the port 62 when the spike portion 50 is pushed therein. As the spike portion 50 is pushed into the port 62, the fingers 90 are configured to flex in a radially outward direction to accommodate positioning of the port 62 about the spike portion 50—with the fingers 90 then applying a 360° radially inward-directed force against the port 62, to push the port 62 against the spike portion 50. The fingers 90 thus function to prevent dislodgment of the spike portion 50 from injection port 14, so as to secure the adapter 10 with the infusion fluid container 60.

In some embodiments, the snap connector 86a, 86b, 86c, 86d may comprise a silicone layer or ring (not shown) thereon at an area of engagement between the spike portion 50 and port 62 that acts as seal to prevent leakage. In some embodiments, such as the snap connectors of FIGS. 17 and 18, the silicone layer/ring may be provided on base ring 88, with an end of port 62 engaging the silicone layer/ring when the spike portion 50 is fully pushed into port 62.

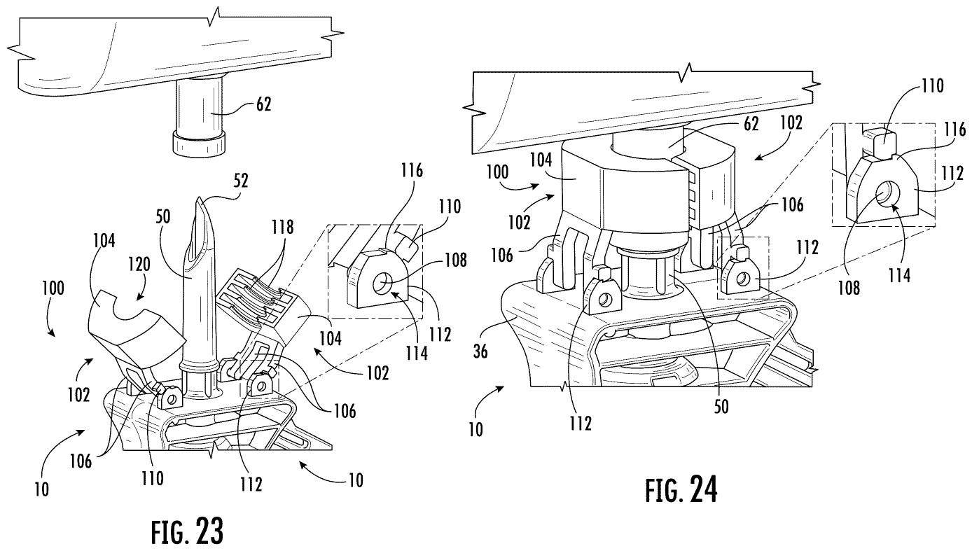

Referring now to FIGS. 23-36, various embodiments of a clamp-type securing mechanism or “clamp connector” that may be included on the infusion adapter 10 are illustrated, according to embodiments of the disclosure. In some embodiments, the clamp connector (or portions thereof) may be integrally formed with the adapter 10 (i.e., with main body 36), while in other embodiments the clamp connector (or portions thereof) may be affixed to the adapter 10 via an appropriate mechanical connection.

In FIGS. 23 and 24, an infusion adapter 10 is illustrated that includes a clamp connector 100 in the form of a pair of rotatable grip tabs 102 that are joined to the adapter 10. Each of the grip tabs 102 is generally composed of a C-shaped grip member 104 and a pair of arms 106 that protrude out from the grip member 104, with the arms 106 arranged in a spaced-apart manner. Each of the arms 106 includes a hinge pin 108 formed at a bottom end thereof, as a well as a snap pin 110 that is spaced apart from the hinge pin 108. The hinge pins 108 provided on the arms 106 are configured to engage with ribs 112 formed on the main body 36 of adapter 10 (i.e., on stop 56), with the ribs 112 extending upward from main body 36 and each including a pin hole 114 therein that receives a respective hinge pin 108—such that the ribs 112 function as pivot points for the grip tabs 102. A pair of ribs 112 is provided on main body 36 on each of opposing sides of the spike portion 50, such that the grip tabs 102 may be rotatably connected to adapter 10 on opposite sides of the spike portion 50. In some embodiments, an upper surface of each rib 112 may include a bump 116 formed thereon that may selectively engage with the snap pin 110 of a respective arm 106 as the arm is angularly rotated relative to the main body 36.

Each grip member 104 comprises a plurality of grip features 118 provided in a stacked arrangement. The grip features 118 are configured to contact the port 62 of infusion fluid container 60 after pushing of the spike portion 50 into port 62 and after rotation of the grip tab 102 to an engaged position. Each grip member 104 includes a semi-circular cut-out 120 formed therein into which the spike portion 50 may be positioned, such that the grip member 104 partially surrounds the spike portion 50 when brought into contact therewith, and such that the grip members 104 may entirely surround the spike portion 50 when both the grip tabs 102 are moved to the engaged position.

In using the grip tabs 102 to secure the adapter 10 to the infusion fluid container 60, the grip tabs 102 are initially provided in an open position or configuration, with the grip tabs 102 separated from one another. With the grip tabs 102 in the open position, the spike portion 50 may be pushed into injection port 62 to engage the adapter 10 with the infusion fluid container 60. Once the spike portion 50 is completely inserted into the port 62, the grip tabs 102 are rotated about the pivot points or ribs 112, with the grip tabs 102 being rotated toward each other and toward the engaged position. As the grip tabs 102 are rotated toward the engaged position, the snap pins 110 on the arms 106 slide along a curved top surface of the ribs 112 until the snap pins 110 slide past the bump 116 formed thereon. Once the snap pin 110 on each arm 106 is slipped past the bump 116 of rib 112, the grip tab 102 is locked into place in the engaged position. With both grip tabs 102 in the engaged position, the grip members 104 of the grip tabs 102 are brought into contact with each other and into contact with the injection port 62—with the grip features 118 of each grip member 102 applying a compression force against the port 62 and the spike portion 50 positioned therein that prevents dislodgement of the spike portion 50 from the port 62, such that adapter 10 remains connected to infusion fluid container 60.

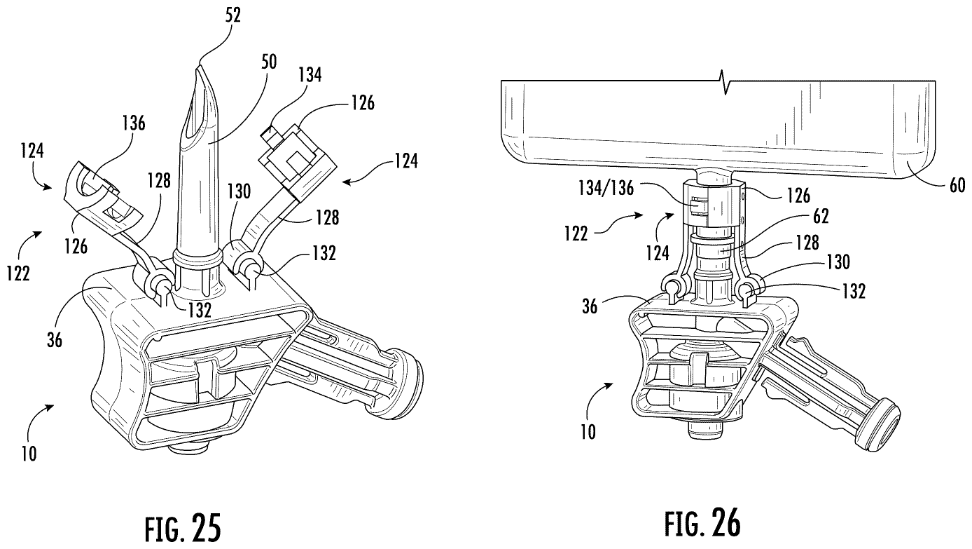

Referring now to FIGS. 25 and 26, an infusion adapter 10 is illustrated that includes a clamp connector 122 in the form of a pair of rotatable friction clamps 124 that are joined to the adapter 10. Each of the friction clamps 124 is generally composed of a C-shaped grip member 126 and an arm 128 that protrudes outs from the grip member 126. The arm 128 of each friction clamp 124 includes a clip 130 formed at a bottom end thereof that is configured to engage with a protrusion 132 formed on the main body 36 of adapter 10 (i.e., on stop 56), with each protrusion 132 comprising a horizontally oriented cylindrical protrusion that extends upward from main body 36. A protrusion 132 is provided on main body 36 on each of opposing sides of the spike portion 50, such that the friction clamps 124 may be rotatably connected to adapter 10 on opposite sides of the spike portion 50.

The C-shaped grip member 126 of each friction clamp 124 is configured to contact the port 62 of infusion fluid container 60 after pushing of the spike portion 50 into port 62 and after rotation of the grip member 126 to an engaged position. The C-shaped grip member 126 of one of the friction clamps 124 may comprise a pair of engagement tabs 134 formed on opposing ends thereof, while the C-shaped grip member 126 of the other friction clamp may comprise a pair of engagement receptacles 136 formed on opposing ends thereof. The engagement tabs 134 and receptacles 136 are configured to mate with each other when the friction clamps 124 are moved/rotated to an engaged position, thereby secured the friction clamps 124 together and providing a clamp connector 122 that secures the port 62 to the spike portion 50.

In using the friction clamps 124 to secure the adapter to the infusion fluid container 60, the friction clamps 124 are initially provided in an open position or configuration, with the friction clamps 124 separated from one another. With the friction clamps 124 in the open position, the spike portion 50 may be pushed into port 62 to engage the adapter 10 with the infusion fluid container 60. Once the spike portion 50 is completely inserted into the port 62, the friction clamps 124 are rotated about the cylindrical protrusions 132 on main body 36, with the friction clamps 124 being rotated toward each other and toward the engaged position. With the friction clamps 124 rotated to the engaged position, the engagement tabs 134 and receptacles 136 are brought into contact with each other, with the tabs 134 inserted and locked into the receptacles 136 to secure the friction clamps 124 together. With the friction clamps 124 secured together in the engaged position, the grip members 126 of the friction clamps 124 are brought into an interference fit with the injection port 62—with each grip member 126 applying a compression force against the port 62 and the spike portion 50 positioned therein that creates friction therebetween to prevent dislodgement of the spike portion 50 from the port 62, such that adapter 10 remains connected to infusion fluid container 60.

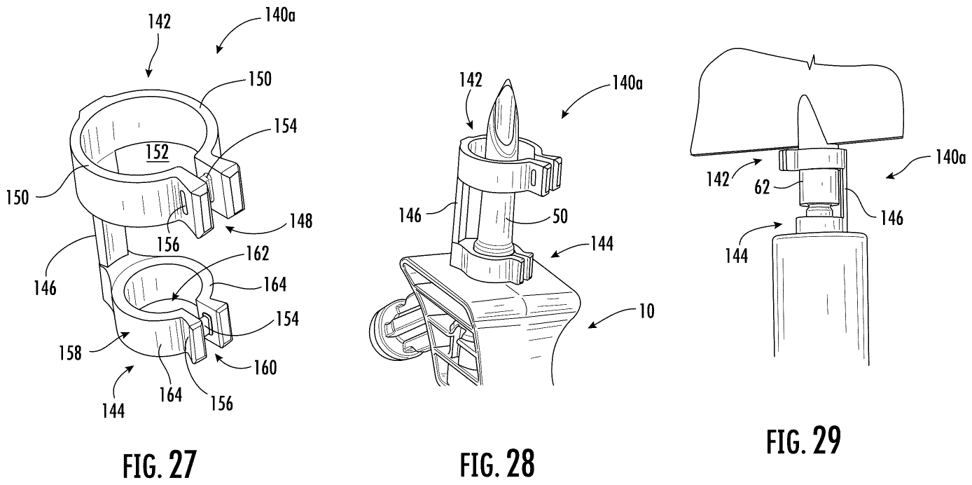

Referring now to FIGS. 27-34, infusion adapters 10 are illustrated that include a clamp connector 140a, 140b, 140c that is joined to the adapter 10. The clamp connector 140a, 140b, 140c in each of the embodiments of FIGS. 27-34 may be characterized as generally including an annular port clamp 142, an adapter engagement member 144, and a connecting arm 146 extending between the port clamp 142 and the adapter engagement member 144.

For each of clamp connectors 140a, 140b, 140c, the annular port clamp 142 is formed as an annular-shaped clamp member that has a slit 148 formed therein to separate the port clamp 142 into a pair of flexible arms 150 that may deflect when a force is applied thereto. The port clamp 142 is configured to be positioned about the port 62 and spiked portion 50 after pushing of the spike portion 50 into port 62, so as to secure the adapter 10 to infusion fluid container 60. That is, when the port clamp 142 is pushed into contact with the injection port 62 and spike portion 50 at the location of slit 148, the slit 148 is caused to expand and the flexible arms 150 separate, such that the injection port 62 and spike portion 50 may be pushed into the opening or receptacle 152 defined by the cylindrical port clamp 142.

In some embodiments, the annular port clamp 142 may include a locking mechanism via which the arms of the port clamp 142 may then be locked together to secure the annular port clamp 142 in place about the injection port 62 and spike portion 50. In an exemplary embodiment, the arms 150 of the port clamp 142 may be locked together via a tongue and groove type lock mechanism. That is, one arm of the port clamp 142 may include a tab or tongue 154 formed at the end thereof, while the other arm of the port clamp 142 may include a slot or groove 156 formed therein configured to receive the tongue 154 therein. A user may actuate/flip the tongue 154 into engagement with the groove 156 upon positioning of the port clamp 142 about the injection port 62 and spike portion 50, to thus lock the port clamp 142 in a closed configuration. With the port clamp 142 in the closed configuration, the arms 150 of the port clamp 142 apply a compression force against the port 62 and the spike portion 50 that prevents dislodgement of the spike portion 50 from the port 62, such that adapter 10 remains connected to infusion fluid container 60.

For each of clamp connectors 140a, 140b, 140c, the adapter engagement member 144 functions to secure the annular clamp connector 140a, 140b, 140c to the infusion adapter 10.

In the embodiment of FIGS. 27-29, the adapter engagement member 144 is configured as an annular spike clamp 158 including a slit 160 formed therein, similar to annular port clamp 142—with the difference being that an opening/receptacle 162 defined by annular spike clamp 158 is smaller than the opening/receptacle 152 defined by annular port clamp 142, such that annular spike clamp 158 is configured to retain spike portion 50 of adapter 10 therein. Similar to annular port clamp 142, arms 164 of annular spike clamp 158 may include tongue and groove features 154, 156 thereon that may lock the arms 164 into engagement with each other upon positioning of the port clamp 142 about the spike portion 50, to thus lock the annular spike clamp 158 in a closed configuration. When the arms 164 are locked into engagement about the spike portion 50, a secure engagement between the clamp connector 140a and the adapter 10 is thus provided, to retain the clamp connectors 140a in place on adapter 10.

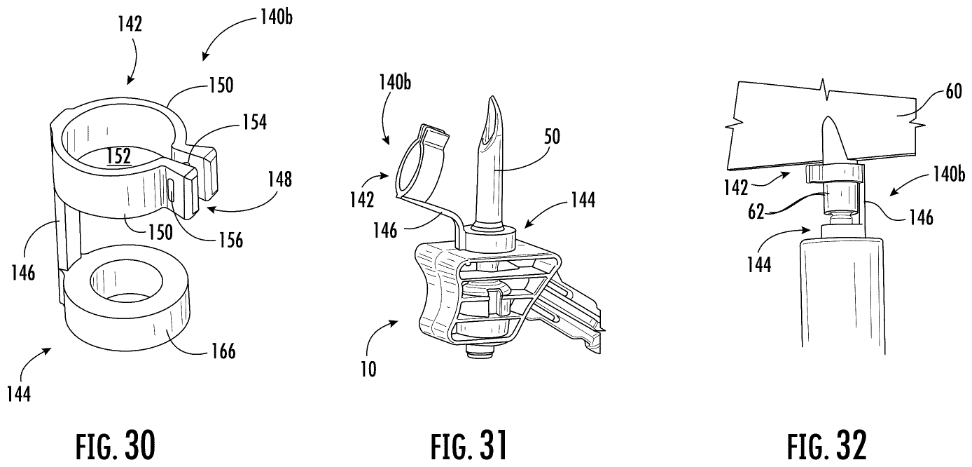

In the embodiment of FIGS. 30-32, the adapter engagement member 144 is configured as a ring member 166 that may be press-fit onto spike portion 50. When pressed onto the spike portion 50, the ring member 166 may thus provide secure engagement between the clamp connector 140b and the adapter 10, to retain the clamp connector 140b in place on adapter 10.

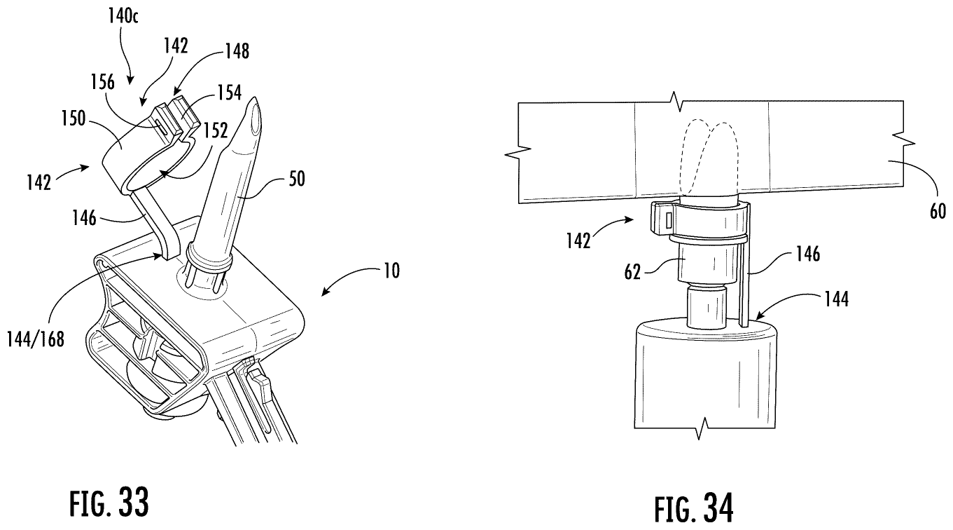

In the embodiment of FIGS. 33 and 34, the adapter engagement member 144 is provided as an integral member of the adapter engagement member 144—i.e., adapter engagement member 144 is formed integrally with the main body 36 of adapter. That is, the adapter engagement member 144 may simply be characterized as a bottom end 168 of the connecting arm 146—with the connecting arm 146 (and all of clamp connector 140c) being integrally formed with the adapter 10 as a single component.

According to embodiments, the connecting arm 146 of clamp connector 140c is configured as a bendable or flexible arm that allows for movement/rotation of the annular port clamp 142 relative to the adapter engagement member 144. Thus, the annular port clamp 142 may be moved away from the spike portion 50 when it is desired to push the spike portion 50 into the injection port 62, and may then be moved back toward the engaged port 62 and spike portion 50, with the annular port clamp 142 then pushed onto the port 62 and spike portion 50 and locked in place to prevent dislodgement of the spike portion 50 from the port 62.

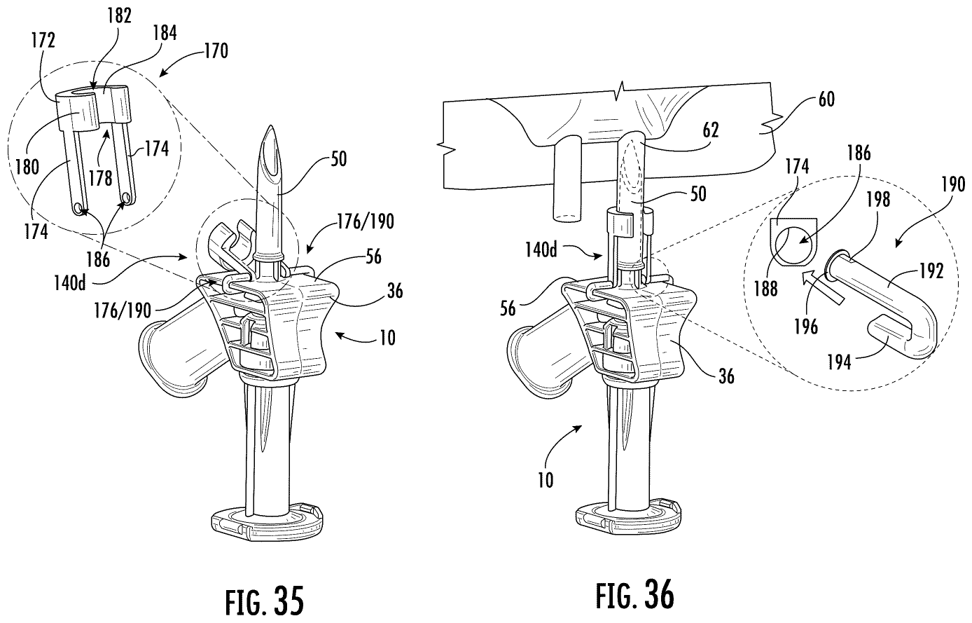

Referring now to FIGS. 35 and 36, a clamp connector 140d is shown according to another embodiment of the disclosure. The clamp connector 140d may be characterized as generally including a clamp member 170 that includes an annular port clamp 172 and a pair of connecting arms 174 integrally formed with the port clamp 172, along with adapter engagement members 176 that provide for securing of the clamp member 170 to the adapter 10.

The port clamp 172 is generally annular in shape but includes a slit 178 formed therein that separates the port clamp 172 into a pair of flexible arms 180 that may deflect when a force is applied thereto. The clamp member 170 is configured to be positioned about the port 62 and spiked portion 50 after pushing of the spike portion 50 into port 62, so as to secure the infusion adapter 10 to infusion fluid container 60. That is, when the port clamp 172 is pushed into contact with the injection port 62 and spike portion 50 at the location of slit 178, the slit 178 is caused to expand and the flexible arms 180 separate, such that the injection port 62 and spike portion 50 may be pushed into the opening or receptacle 182 defined by the cylindrical port clamp 172—with the port clamp 172 providing a snap-fit engagement with the engaged port 62 and spiked portion 50 when secured thereon. In some embodiments, an inner surface of the port clamp 172 can include a rubber padding 184 provided thereon—with the rubber padding 184 configured to provide additional friction (and interference) between the port clamp 172 and the port 62.

The connecting arms 174 of clamp member 170 are integrally formed with annular port clamp 172 and are joined thereto on opposing sides of the port clamp 172. The connecting arms 174 are configured as elongated arms that extend down/away from the port clamp 172, with each of the elongated arms including a circular opening 186 formed at a bottom end thereof. As explained in further detail below, the clamp member 170 may be secured to adapter engagement members 176 via connecting arms 174—with the adapter engagement members 176 inserted into openings 186 of connecting arms 174. In some embodiments, a tooth 188 may be formed in the opening of each connecting arm 174.

The adapter engagement members 176 of clamp connector 140d are configured as a pair of U-shaped clips 190 configured to be secured onto adapter 10. More specifically, U-shaped clips 190 are configured to clip onto main body 36 of adapter 10—with an upper arm 192 of each U-shaped clip 190 being positioned above stop 56 of main body 36 and the U-shaped clip 190 wrapping around a side edge of main body 36 such that a lower arm 194 is positioned below the stop 56 of main body 36. In some embodiments, an upward-facing surface of lower arm 194 may be configured as a flat surface that makes flush contact with an underside of the stop 56 of main body 36, so as to prevent (back) rotation between the U-shaped clip 190 and the main body 36 and therefore maintain the U-shaped clip 190 in place. The U-shaped clips 190 may comprise flexible clips, such that when each U-shaped clip 190 is pushed onto main body 36—with the upper and lower arms 192, 194 positioned above and below the stop 56 of main body 36—the clip 190 is snapped onto the adapter 10 and secured in-place thereon.

As shown in FIG. 36, the upper arm 192 of each U-shaped clip 190 also includes a retention ring 196 at the end thereof, along with a tooth 198 formed thereon that extends radially outward from the upper arm 192. The retention ring 196 of each U-shaped clip 190 functions to secure the clamp connector 140d on the U-shaped clips 190—with a diameter of the retention rings 196 being larger than a diameter of the openings 186 in connecting arms 174 such that the connecting arms 174 are prevented from sliding off of upper arms 192. The tooth 198 formed on each upper arm 192 interacts with the tooth 188 formed in a respective opening 186 in connecting arms 174 to enable the clamp connector 140d to be locked in a position. That is, when the clamp connector 140d is rotated from a disengaged position (where port clamp 172 is not clamped onto the engaged port 62 and spike portion 50) to an engaged position (where port clamp 172 is clamped onto the engaged port 62 and spike portion 50), the teeth 198 of the upper arms 192 and the teeth 188 of openings 186 may engage to lock the clamp connector 140d in the engaged position.

Thus, with the clamp connector 140d forming a snap-fit engagement with the engaged port 62 and spiked portion 50 and being locked at the engaged position, the clamp connector 140d functions to prevent dislodgement of the spike portion 50 from the port 62.

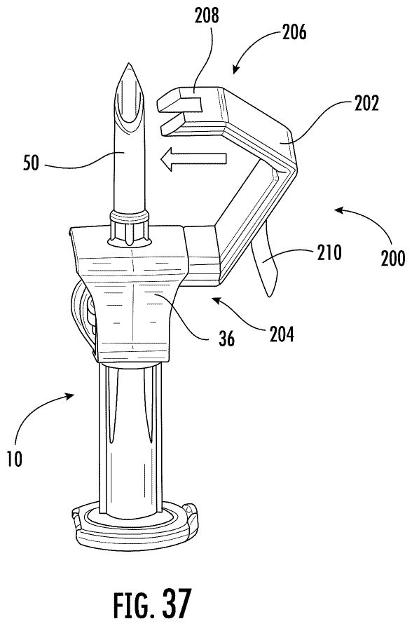

Referring now to FIGS. 37-39 , various latch-type securing mechanisms that may be included on the adapter are illustrated, according to embodiments of the disclosure.

Referring first to FIG. 37, a securing latch 200 is shown that is formed integrally with infusion adapter 10 and that is actuatable from a disengaged position to an engaged position to aid in securing the adapter 10 to infusion fluid container 60. The securing latch 200 is configured as a side arm 202 that includes a first end 204 joined to (and integrally formed with) main body 36 of adapter 10 and a second end 206 that includes a C-shaped collar 208 formed thereon. The C-shaped collar 208 is sized and configured to clamp onto port 62—after spike portion 50 is inserted into and engaged with port 62. The side arm 202 also includes a push tab 210 formed thereon at a location between the first and second ends, with the push tab 210 configured to be engaged by a user to provide for actuation of the side arm 202 from the disengaged position to the engaged position.

In use of securing latch 200, the adapter 10 is first engaged with infusion fluid container 60—with the spike portion 50 inserted into the port 62 and puncturing point 52 being pierced into the infusion fluid container 60. Upon engagement of the spike portion 50 with port 62, a user may then apply force to the push tab 210 to actuate the side arm 202 from the disengaged position to the engaged position. With the side arm 202 moved to the engaged position, the C-shaped collar 208 is pushed onto the engaged port 62 and spike portion 50—with arms of the C-shaped collar 208 flexing when pushed onto the port 62 and spike portion 50 and snapping thereon to lock the side arm 202 in-place. In some embodiments, the C-shaped collar 208 locks onto the engaged port 62 and spike portion 50 at a location just above the port collar 65 to restrict vertical movement between the port 62 and the main spike portion 50 (i.e., prevent the spike portion 50 from being pulled down/out from port 62) to prevent dislodging of the spike portion 50 from the port 62.

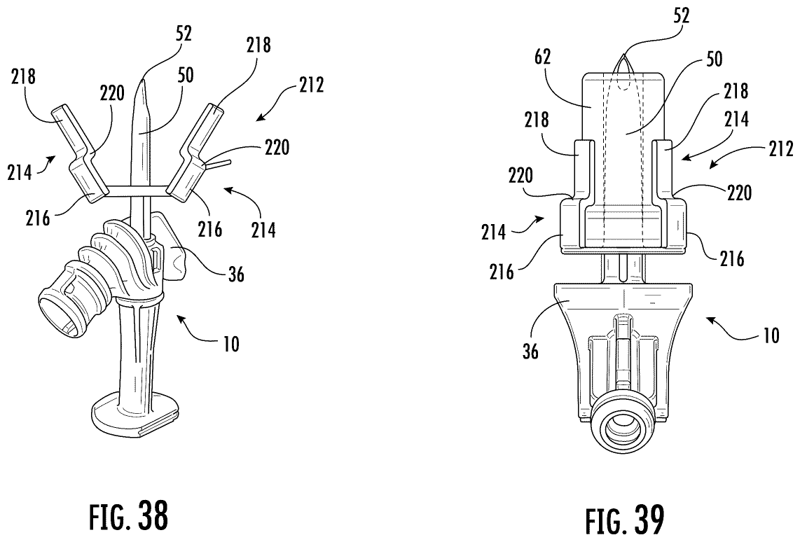

Referring next to FIGS. 38 and 39, a securing latch 212 is shown that is formed integrally with infusion adapter 10 and that is actuatable from a disengaged position to an engaged position to aid in securing the adapter 10 to infusion fluid container 60. The securing latch 212 of FIGS. 38 and 39 comprises a pair of rotatable arms 214 that are provided on opposing sides of the spike portion 50 and that are secured to the main body 36 of the infusion adapter 10. Each of the arms 214 may be characterized as including a first portion 216 and a second portion 218—with the first portion 216 rotatably connected to main body 36 and the second portion 218 forming a free end of the arm. A transition portion 220 connects the first portion 216 to the second portion 218, with the transition portion 220 offsetting the second portion 218 from the first portion 216. That is, while first portion 216 and second portion 218 each comprise a linear segment that are generally arranged in parallel to each other, the transition portion 220 offsets the second portion 218 from the first portion 216 such that when the securing latch 212 is in the engaged position, the second portion 218 is inset radially inward from the first portion 216 (relative to spike portion 50).

When the spike portion 50 is inserted into the port 62 and puncturing point 52 of connecting portion 12 of adapter 10 is pierced into the infusion fluid container 60, the arms 214 may be rotated from their disengaged position to their engaged position, with the arms 214 locking in-place at the engaged position. As the arms 214 are moved to the engaged position, the arms 214 are brought into contact with an external surface of the port 62. The arms 214 are configured such that they may generally conform to the outer surface of the port 62, with transition portion 220 aligned with the port collar 65 such that the radially inset second portion 218 is positioned above/over the port collar 65. The securing latch 212 may thus restrict vertical movement between the port 62 and the main spike portion 50 (i.e., prevent the spike portion 50 from being pulled down/out from port 62) to prevent dislodging of the spike portion 50 from the port 62.

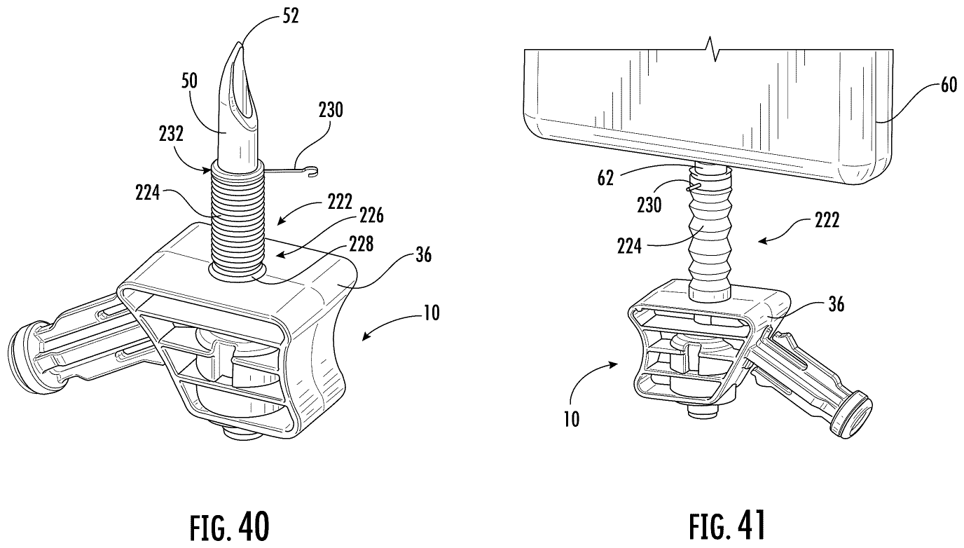

Referring now to FIGS. 40 and 41, a bellows-type securing mechanism 222 (referred to hereafter as a “bellows 222”) that may be included on the infusion adapter 10 is illustrated, according to an embodiment of the disclosure. The bellows 222 comprises an extendable sleeve 224 that is positioned about spike portion 50 and may be actuated upon engaging of the spike portion 50 with port 62 to secure the secure the infusion adapter 10 to the infusion fluid container 60.

The bellows 222 may be formed of a deformable (e.g., elastomeric) material that is configured to be actuated from an initial, shortened configuration to an extended or lengthened configuration. A bottom end 226 of bellows 222 may be attached/secured to adapter 10, such as via a press-fit connection between the bellows 222 and a flange or protrusion 228 provided on main body 36 of the adapter 10—with the bellows 222 extending upwardly from its bottom end to cover a lower half of spike portion 50 (when in its shortened configuration). With the bellows 222 in its shortened configuration, the spike portion 50 may be inserted into port 62—with the puncturing point 52 piercing a seal of infusion fluid container 60 to place the adapter 10 in fluid communication with the infusion fluid container 60. Upon the spike portion 50 engaging port 62 and being positioned therein, the bellows 222 may be extended upward so that the bellows 222 is pulled onto and over at least a portion of port 62. With the bellows 222 in its extended configuration, a tightening member 230—such as a zip-tie-may be secured about an upper end 232 of the bellows 222 and tightened thereabout. The tightening member 230 thus secures the bellows 222 in its extended configuration and retains the bellows 222 in-place on the engaged port 62 and spike portion 50. With the tightening member 230 tightened and the bellows 222 secured in-place on the engaged port 62 and spike portion 50, the bellows 222 functions to prevent dislodging of the spike portion 50 from port 62 responsive to any pull-apart force that may be applied to the spike portion 50 of adapter 10 and/or port 62 of infusion fluid container 60—with the bellows 222 stretching and providing a slack length before actual dislodgement would occur.

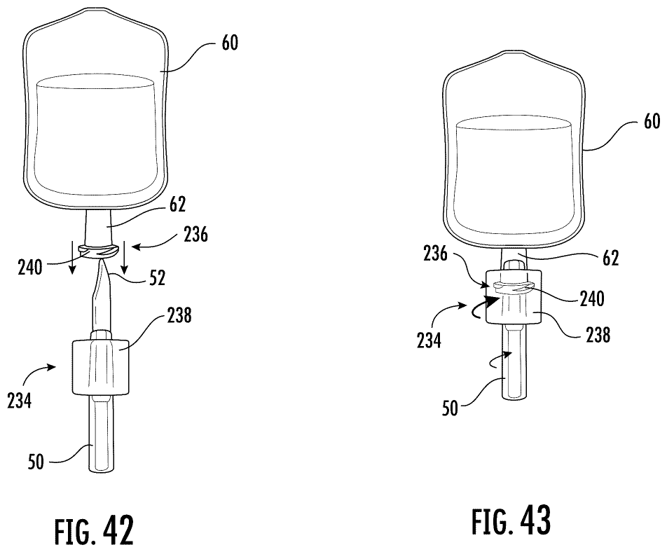

Referring now to FIGS. 42 and 43, a luer connection securing mechanism that may be included on the infusion adapter 10 and infusion fluid container 60 is illustrated, according to an embodiment of the disclosure. In providing a luer connection securing mechanism between the adapter 10 and infusion fluid container 60, a luer connector is provided on each of the adapter 10 and the infusion fluid container 60. In an exemplary embodiment, adapter 10 includes a male luer connector 234 provided on spike portion 50, while infusion fluid container 60 includes a female luer connector 236 on port 62.

The male luer connector 234 comprises a cylindrical rotating collar 238 having a threaded inner surface configured to threadingly engage the male luer connector 234 to the female luer connector 236 of port 62. The rotating collar 238 is positioned on/over the spike portion 50, proximate the puncturing point 52 and is rotatable relative to the spike portion 50, to provide for actuation of the rotating collar 238 that brings the rotating collar 238 into threading engagement with the female luer connector 236.

The female luer connector 236 on port 62 may comprise a luer lug 240 positioned at an end of port 62. In some embodiments, the luer lug 240 is integrated with port 62, while in other embodiments the luer lug 240 is pre-fixed or secured within port 62 prior to engaging of the infusion adapter 10 with infusion fluid container 60. The luer lug 240 includes a threaded outer surface configured to engage the threaded inner surface of rotating collar 238 of the male luer connector 234 74.

Upon the spike portion 50 engaging port 62 and being positioned therein (so that the puncturing point pierces a seal of infusion fluid container 60 to place the adapter 10 in fluid communication with the infusion fluid container 60), the female luer connector 236 on port 62 is brought adjacent to male luer connector 234 on adapter. A user may then actuate/twist the rotating collar 238 to bring the rotating collar 238 into threaded engagement with the threaded outer surface of luer lug 240. The threaded engagement between the luer lug 240 and rotating collar 238 acts to prevent dislodgment of the spike portion 50 from the port 62, thereby locking the adapter 10 into engagement with the infusion fluid container 60.

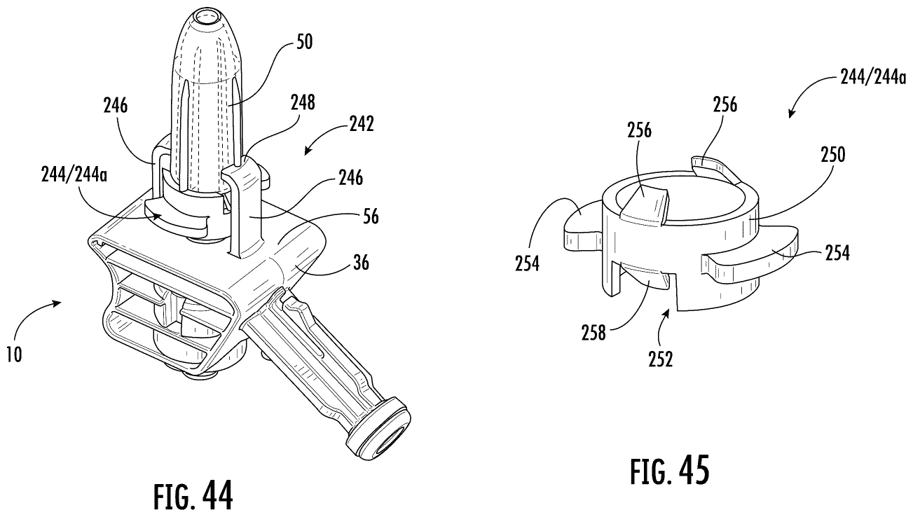

Referring now to FIGS. 44-51, adapters are illustrated that include a securing mechanism in the form of a pin holder type securing mechanism (hereafter “pin holder connector”) that is joined/secured to the infusion adapter 10.

Referring first to FIGS. 44-46 and FIGS. 47-49, the pin holder connector 242 may be characterized as generally including a movable inner cylinder 244 and support protrusions 246.

The support protrusions 246 are formed integrally with the adapter 10, with the support protrusions 246 configured as elongated members that extend upward/away from the stop 56 of main body 36, and with the support protrusions 246 positioned on opposing sides of spike portion 50. Each of the support protrusions 246 includes a hook 248 formed at the end thereof that curves inwardly toward spike portion 50.

The movable inner cylinder 244 is positioned about spike portion 50 at the end thereof where spike portion 50 joins main body 36. The movable inner cylinder 244 is configured to move relative to spike portion 50, with the movable inner cylinder 244 sliding up/down along the spike portion 50. A range of movement of the movable inner cylinder 244 along spike portion 50 is restricted by the support protrusions 246, with the hooks 248 formed on the support protrusions 246 preventing movement of the movable inner cylinder 244 up past the support protrusions 246. The movable inner cylinder 244 is pre-assembled with the adapter 10, such that that movable inner cylinder 244 is positioned on adapter 10 prior to connection of the adapter 10 with the infusion fluid container 60.

In the embodiment of FIGS. 44-46, the movable inner cylinder 244a comprises a generally tube-shaped main body 250. The main body 250 includes a pair of notches 252 formed therein at a bottom end of the main body 250, with the notches 252 positioned on opposing sides of the main body 250. A pair of grippers 254 are provided on the main body 250 and extend radially outward therefrom, with the grippers 254 positioned on opposing sides of the main body 250. The grippers 254 allow for a user to engage the movable inner cylinder 244a and move the movable inner cylinder 244a relative to the spike portion 50 (and port 62). Also provided on the main body 250 are a pair of upper pins 256 and a pair of lower pins 258. The upper pins 256 are provided on a top end of the main body 250, along a circumferential edge thereof and on opposing sides of the main body 250—with the upper pins 256 angled to extend upward from the top end and radially inward. The lower pins 258 are provided within the notches 252 formed in main body 250, along a circumferential edge thereof and on opposing sides of the main body 250—with the lower pins 258 angled to extend downward and radially inward.

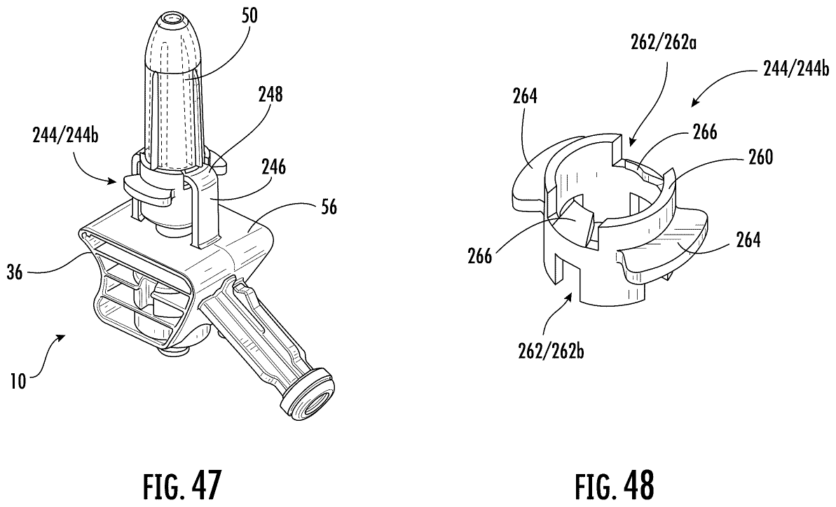

In the embodiment of FIGS. 47-49, the movable inner cylinder 244b comprises a generally tube-shaped main body 260. The main body 260 includes notches 262 formed therein at both a bottom end of the main body 260 and a top end of the main body 260—with a pair of upper notches 262a formed on opposing sides of the main body 260 at the top end and four (4) lower notches 262b spaced circumferentially about the main body 260 at the bottom end. A pair of grippers 264 are provided on the main body 260 and extend radially outward therefrom, with the grippers 264 positioned on opposing sides of the main body 260. The grippers 264 allow for a user to engage the movable inner cylinder 244b and move the movable inner cylinder 244b relative to the spike portion 50 (and port 62). Also provided on the main body 260 are a pair of upper pins 266. The upper pins 266 are provided at the top end of the main body 260 and positioned within the upper notches 262a formed in main body 260, along a circumferential edge thereof and on opposing sides of the main body 260—with the upper pins 266 angled to extend upward and radially inward.

In using the pin holder connector 242 to secure the adapter 10 to infusion fluid container 60, the spike portion 50 is first engaged with port 62 such that the spike portion 50 is positioned within port 62 and the puncturing point 52 pierces a seal of infusion fluid container 60 to place the adapter 10 in fluid communication with the infusion fluid container 60. Once this spiking action is completed, a user pushes/slides the movable inner cylinder 244 upwards via use of grippers 254, 264—with the movable inner cylinder 244 being moved from an initial position (where movable inner cylinder 244 does not engage port 62, or minimally engages port 62) to an engaged position (where movable inner cylinder 244 fully engages port 62). With the movable inner cylinder 244 pushed upwards to the engaged position, the movable inner cylinder 244 engages port 62 and is positioned/retained between the spike collar 54 and the hooks 248 of support protrusions 246. In the embodiment of FIGS. 44-46, with the movable inner cylinder 244a in the engaged position, the upper pins 256 engage the hooks 248 and the lower pins 258 engage the spike collar 54. In the embodiment of FIGS. 47-49, with the movable inner cylinder 244b in the engaged position, the upper pins 266 engage the hooks 248, while the bottom edge of main body 260 engages the spike collar 54. In the event that a downward directed pulling force is applied to the adapter 10 (and spike portion 50), the pin holder connector 242 prevents dislodgment of the spike portion 50 from the port 62 via upper pins 256, 266 engaging hooks 248 (and resisting the downward directed pulling force) and via the upper pins 256, 266 (and lower pins 258, in the embodiment of FIGS. 44-46) applying a radially inward-directed pinching/compression force against the port 62, to better retain spike portion 50 within port 62.

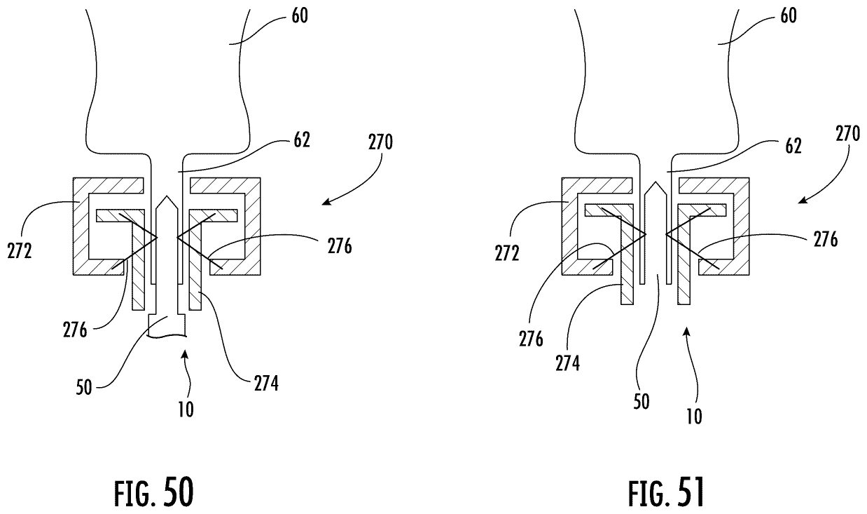

Referring now to FIGS. 50 and 51, a pin holder connector 270 is shown according to another embodiment of the disclosure. The pin holder connector 270 generally comprises an outer cylinder 272 configured to attach to injection port 62 of infusion fluid container 60, an inner cylinder 274 configured to attach to spike portion 50 of adapter 10, and V-shaped pins 276 attached on both sides of port 62—with one end of each V-shaped pin 276 attached to the outer cylinder 272 and the other end of each V-shaped pin 276 attached to inner cylinder 274. When a patient pulls a spike line (not shown) extending out from adapter 10, the inner cylinder 274 pulls down, thus causing the V-shaped pins 276 to pinch the port 62 onto spike portion 50, to tighten the grip therebetween.

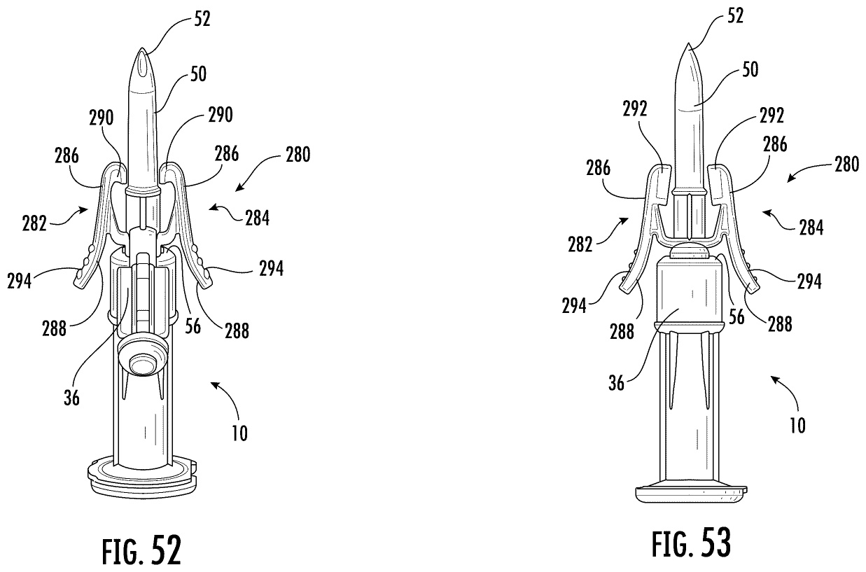

Referring now to FIGS. 52-55, adapters are illustrated that include a securing mechanism in the form of a hinged clip securing mechanism (hereafter “hinge clip”) that is integrally formed with or secured to the infusion adapter 10.

Referring first to FIGS. 52 and 53, a hinged clip connector 280 includes a first clip arm 282 and a second clip arm 284 that are positioned on opposing sides of the spike portion 50. Each of the first clip arm 282 and the second clip arm 284 includes an engagement portion 286 and an actuation portion 288. The engagement portion 286 extends up past stop 56 of main body and up along a partial length of spike portion 50. The engagement portion 286 may comprise a hook/wedge 290 (FIG. XX) or knurling 292 (FIG. XX) at a far end thereof that enables the engagement portion 286 to mate with the port 62, i.e., port collar 65, when engaged therewith. The actuation portion 288 may comprise a finger press 294 positioned at an opposing end of the clip arm 282, 284 from engagement portion 286, with the finger press 294 on the clip arms 282, 284 enabling a user to apply a pinching force to the hinged clip connector 280. When a pinching force is applied to the finger presses 294 of hinged clip connector 280, the first clip arm 282 and second clip arm 284 are caused to separate further, which allows spike portion 50 to be pressed into and engaged with port 62. Upon engaging of the spike portion 50 with port 62, the finger presses 294 of hinged clip connector 280 may be released, which allows the first clip arm 282 and second clip arm 284 to move back toward each other (due to biasing of the first clip arm 282 and second clip arm 284). Upon the first clip arm 282 and second clip arm 284 moving back to their original “closed” position, the engagement portion 286 of the arms 282, 284 contact the port 62, such as by hooking onto or otherwise engaging the port collar 65 of port 62. With the hinged clip connector 280 engaging the port 62 in this manner, the hinged clip connector 280 functions to restrict vertical movement between the port 62 and the main spike portion 50 (i.e., prevent the spike portion 50 from being pulled down/out from port 62) to prevent dislodging of the spike portion 50 from the port 62.

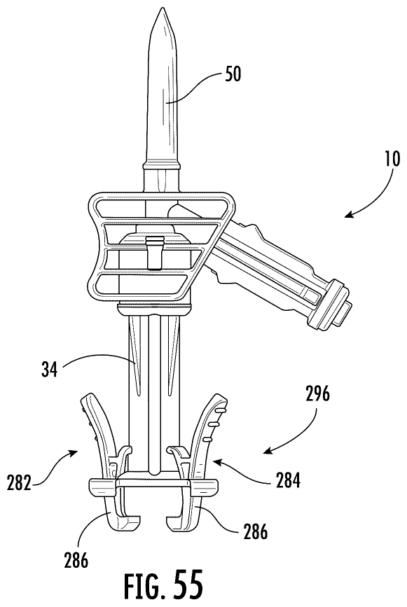

Referring to FIG. 55, in another embodiment, a hinged clip connector 296 may be provided on intravenous line connector 34 of adapter 10. With the hinged clip connector 296 provided at this location, the hinged clip connector 296 may aid in securing an IV set or line (not shown) to the adapter 10, with the engagement portion 286 of the first clip arm 282 and the second clip arm 284 mating with a corresponding feature provided on the IV set/line to secure the IV set/line with the adapter 10 in the event of an external pulling force being applied on the IV line.

Beneficially, embodiments of the invention thus are directed to securing mechanisms for securely engaging an infusion adapter with an infusion fluid container, in order to prevent dislodging of the spike connector of the adapter from the injection port and potential medication leakage from the infusion fluid container. The securing mechanism may be integrally formed with the infusion adapter or pre-fixed with the infusion adapter prior to engagement of the adapter with the infusion fluid container—with the securing mechanism positionable about the injection port of the infusion fluid container and the main spike portion of the infusion adapter after the main spike portion has been engaged with the injection port. The securing mechanism functions to secure the injection port and the main spike portion together by restricting vertical movement between the port and the main spike portion, so as to prevent dislodging of the main spike portion from the injection port.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment may be combined with one or more features of any other embodiment.

The invention claimed is:

1. A fluid transfer system comprising:
an infusion fluid container containing an infusion fluid therein, the infusion fluid container comprising a port having a fluid barrier member therein;
an infusion adapter for connection with the infusion fluid container, the infusion adapter comprising a main body and a connection spike positioned at a first end of the main body, the connection spike having a main spike portion and a puncturing point configured to engage the port, with the port positioned about the main spike portion when engaged therewith;
wherein the infusion adapter comprises a securing mechanism configured to secure the main spike portion within the port when engaged therewith, with the securing mechanism restricting vertical movement between the port and the main spike portion to prevent dislodging of the main spike portion from the port.

2. The fluid transfer system of claim 1, wherein the securing mechanism comprises a pair of adhesive strips secured to the main spike portion and provided on both sides thereof, with each of the adhesive strips configured as a flexible strip that is bendable to bring the adhesive strip into contact with an external surface of the port.

3. The fluid transfer system of claim 1, wherein the securing mechanism comprises a pair of flexible fingers secured to the main body of the infusion adapter and positioned on opposing sides of the main spike portion, with each of the fingers including an adhesive layer thereon, and wherein the pair of flexible fingers are configured to bend to bring the adhesive layers thereon into contact with an external surface of the port.

4. The fluid transfer system of claim 1, wherein the securing mechanism comprises a raised enclosure secured to the main body of the infusion adapter, with the raised enclosure positioned about a bottom region of the main spike portion such that a gap is present between the raised enclosure and the main spike portion to accommodate positioning of the port therein, and wherein an adhesive liner is provided on an inner surface of the raised enclosure that bonds the port to the enclosure when the main spike portion is engaged with the port.

5. The fluid transfer system of claim 1, wherein the securing mechanism comprises a snap connector positioned about a bottom region of the main spike portion, the snap connector including:
a base ring having an opening therein through which the main spike portion extends; and
a plurality of fingers arranged circumferentially about the base ring, the plurality of fingers configured to flex and engage the port when the main spike portion is pushed into the port, with the plurality of fingers applying a radially inward-directed force against the port, to push the port against the spike portion.

6. The fluid transfer system of claim 1, wherein the securing mechanism comprises a clamp connector including a pair of rotatable grip tabs positioned on opposing sides of the main spike portion, each of the pair of rotatable grip tabs comprising a C-shaped grip member and a pair of arms that protrude out from the C-shaped grip member, with each of the pair of rotatable grip tabs rotatably joined to the main body of the adapter via a pair of ribs formed on the main body; and
wherein the pair of rotatable grip tabs are actuatable from an open position where the pair of grip tabs is separated from one another to an engaged position where the pair of grip tabs is brought into contact with each other such that the C-shaped grip members thereof apply a compression force against the port and the main spike portion engaged therein.

7. The fluid transfer system of claim 6, wherein for each of the pair of rotatable grip tabs, each of the pair of arms thereof includes a hinge pin and a snap pin formed at a bottom end thereof, with the hinge pin engaging a pin hole formed in a respective rib of the pair of ribs to allow for rotation of the rotatable grip tab and the snap pin engaging a bump formed on an upper surface of a respective rib of the pair of ribs to provide for locking of the rotatable grip tab in the engaged position.

8. The fluid transfer system of claim 1 wherein the securing mechanism comprises a clamp connector including a pair of rotatable friction tabs positioned on opposing sides of the main spike portion, each of the pair of rotatable friction tabs comprising a C-shaped grip member and an arm that protrudes out from the C-shaped grip member, with each of the pair of rotatable friction tabs rotatably joined to the main body of the adapter via a protrusion formed on the main body; and
wherein the pair of rotatable friction tabs are actuatable from an open position where the pair of friction tabs is separated from one another to an engaged position where the pair of friction tabs is brought into contact with each other such that the C-shaped grip members form an interference fit with the port and apply a compression force against the port and the main spike portion.

9. The fluid transfer system of claim 8, wherein the C-shaped grip member of one of the pair of friction clamps comprises a pair of engagement tabs and the C-shaped grip member of the other of the pair of friction clamps comprises a pair of receptacle, with the pair of engagement tabs and the pair or receptacles configured to mate with each other when the friction clamps are moved to the engaged position, to lock the pair of friction clamps together.

10. The fluid transfer system of claim 1, wherein the securing mechanism comprises a clamp connector including:
an annular port clamp having a slit formed therein that separates the annular port clamp into a pair of flexible arms that may deflect when a force is applied thereto;
an adapter engagement member configured to secure the clamp connector to the infusion adapter; and
a connecting arm extending between the annular port clamp and the adapter engagement member;
wherein with the port positioned about the main spike portion, the annular port clamp may be pushed onto the engaged port and main spike portion at a location of the slit, with the engaged port and main spike portion retained within a receptacle defined by the annular port clamp.

11. The fluid transfer system of claim 10, wherein the annular port clamp comprises a locking mechanism configured to secure a first flexible arm of the pair of flexible arms to a second flexible arm of the pair of flexible arms, thereby locking the annular port clamp in-place around the engaged port and main spike portion.

12. The fluid transfer system of claim 10, wherein the adapter engagement member comprises an annular spike clamp having a slit formed therein that separates the annular spike clamp into a pair of flexible arms that may deflect when a force is applied thereto, and wherein the annular spike clamp may be pushed onto a bottom section of the main spike portion at a location of the slit, with the main spike portion retained within a receptacle defined by the annular spike clamp.

13. The fluid transfer system of claim 10, wherein the adapter engagement member comprises a ring member configured to be press-fit onto the main spike portion to secure the clamp connector to the infusion adapter.

14. The fluid transfer system of claim 10, wherein the adapter engagement member comprises a bottom end of the connecting arm, with the bottom end formed integrally with the main body of the infusion adapter.

15. The fluid transfer system of claim 1, wherein the securing mechanism comprises a clamp connector including:
a pair of U-shaped clips configured to attach to the main body of the infusion adapter, each of the pair of U-shaped clips including an upper arm and a lower arm, with each of the pair of U-shaped clips attached to the main body such that the upper arm is positioned above a stop of the main body and the U-shaped clip wraps around a side edge of the main body such that the lower arm is positioned below the stop; and
a clamp member comprising:
an annular port clamp having a slit formed therein that separates the annular port clamp into a pair of flexible arms that may deflect when a force is applied thereto; and
a pair of connecting arms integrally formed with the annular port clamp and positioned on opposing sides thereof, the pair of connecting arms extending away from the annular port clamp and each including an opening formed at a bottom end thereof, with the upper arm of each of the pair of U-shaped clips inserted into the opening, such that the clamp member is rotatably coupled to the pair of U-shaped clips and is movable from a disengaged position where the annular port clamp is not clamped onto the engaged port and main spike portion to an engaged position where the annular port clamp is clamped onto the engaged port and main spike portion;
wherein with the port positioned about the main spike portion, the clamp member may be rotated and the annular port clamp pushed onto the engaged port and main spike portion at a location of the slit, with the engaged port and main spike portion retained within a receptacle defined by the annular port clamp.

16. The fluid transfer system of claim 15, wherein the upper arm of each of the U-shaped clips includes a first tooth formed thereon and each arm of the pair of connecting arms includes a second tooth therein extending into the opening, with the first tooth and the second tooth engaging each other when the clamp member is in the engaged position, so as to lock the clamp member in the engaged position.

17. The fluid transfer system of claim 1, wherein the securing mechanism comprises a securing latch including:
a side arm having a first end joined to the main body of the infusion adapter and a free second end;
a C-shaped collar formed at the free second end of the second end, with the C-shaped collar sized and configured to clamp onto the engaged port and main spike portion; and
a push tab formed on the side arm at a location between the first and second ends, with the push tab configured to be engaged by a user to actuate the side arm from a disengaged position where the C-shaped collar is separated from the engaged port and main spike portion to an engaged position where the C-shaped collar is secured to the engaged port and main spike portion.

18. The fluid transfer system of claim 1, wherein the securing mechanism comprises a securing latch including a pair of rotatable arms connected to the main body of the infusion adapter on opposing sides of the main spike portion and rotatable from a disengaged position to an engaged position, where each of the pair of rotatable arms includes:
a first linear portion rotatably connected to the main body;
a second linear portion forming a free end of the arm and in parallel with the first linear portion; and
a transition portion connecting the first linear portion to the second linear portion, with the transition portion offsetting the second linear portion from the first linear portion such that, when the securing latch is in the engaged position, the second linear portion is inset radially inward from the first linear portion relative to the main spike portion;
wherein with the securing latch in the engaged position, the pair of rotatable arms contact the port and conform to an outer surface thereof, with the transition portion aligned with a collar of the port such that the radially inset second portion is positioned over the collar.

19. The fluid transfer system of claim 1, wherein the securing mechanism comprises a bellows including an extendable sleeve positioned about the main spike portion and that is actuatable from a shortened configuration to an extended configuration;
wherein with the extendable sleeve in the shortened configuration, the main spike portion may engage the port, and with the extendable sleeve in the extended configuration, the extendable sleeve extends over the engaged port and main spike portion.

20. The fluid transfer system of claim 19, further comprising a tightening member positionable over the bellows when the extendable sleeve is in the extended configuration, with the tightening member securing the bellows to the engaged port and main spike portion.

21. The fluid transfer system of claim 1, wherein the securing mechanism comprises a male luer connector comprising a rotating collar positioned on the main spike portion, proximate the puncturing point, with the rotating collar rotatable relative to the main spike portion; and
wherein the port comprises a female luer connector comprising a luer lug positioned at an end of the port, with a threaded inner surface of the rotating collar configured to be brought into threaded engagement with a threaded outer surface of the luer lug when the main spike portion is engaged with the port.

22. The fluid transfer system of claim 1, wherein the securing mechanism comprises a pin holder connector comprising:
a pair of support protrusions formed integrally with the main body of the infusion adapter and each including a hook at a free end thereof, the pair of support protrusions positioned on opposing sides of the main spike portion and extending upward a partial length of the main spike portion; and
a movable inner cylinder positioned about the main spike portion, at a bottom end thereof, and movable relative to the main spike portion and the pair of support protrusions, with movement of the movable inner cylinder restricted by the hooks of the pair of support protrusions;
wherein the movable inner cylinder comprises:
a tube-shaped main body including notches formed therein;
grippers formed on opposing sides of the tube-shaped main body and extending radially outward therefrom, the grippers configured to be engaged by a user to facilitate movement of the movable inner cylinder relative to the main spike portion; and
a plurality of pins formed on the tube-shaped main body, along a circumferential edge thereof, with each of the plurality of pins extending radially inward;
wherein, with the port positioned about the main spike portion, the movable inner cylinder is configured to move from an initial position where the movable inner cylinder does not engage the port to an engaged position where the movable inner cylinder fully engages the port; and
wherein, with the movable inner cylinder in the engaged position, the movable inner cylinder is retained between a spike collar of the main spike portion and the hooks of the support protrusions.

23. The fluid transfer system of claim 22, wherein the notches comprise a pair of notches formed at a bottom end of the tube-shaped main body, on opposing sides thereof; and
wherein the plurality of pins comprises:
a pair of upper pins provided on a top end of the tube-shaped main body, along the circumferential edge thereof and on opposing sides of the tube-shaped main body and angled to extend upward from the top end and radially inward; and
a pair of lower pins provided within the pair of notches, along the circumferential edge of the tube-shaped main body and on opposing sides of the tube-shaped main body, with the lower pins angled to extend downward and radially inward;
wherein, with the movable inner cylinder in the engaged position, the upper pins engage the hooks and the lower pins engage the spike collar.

24. The fluid transfer system of claim 22, wherein the notches comprise a pair of upper notches formed at a top end of the tube-shaped main body, on opposing sides thereof and a plurality of lower notches formed at a bottom end of the tube-shaped main body and spaced circumferentially thereabout; and
wherein the plurality of pins comprise a pair of upper pins provided within the pair of upper notches, along the circumferential edge of the tube-shaped main body and on opposing sides of the tube-shaped main body, with the pair of upper pins angled to extend upward and radially inward;
wherein, with the movable inner cylinder in the engaged position, the upper pins engage the hooks and a bottom edge of the tube-shaped main body engages the spike collar.

25. The fluid transfer system of claim 1, wherein the securing mechanism comprises a pin holder connector including:
an outer cylinder attached to the port;
an inner cylinder attached to the main spike portion; and
V-shaped pins attached on both sides of the port, with one end of each V-shaped pin attached to the outer cylinder and another end of each V-shaped pin attached to the inner cylinder;
wherein the V-shaped pins are configured to pinch the port onto the main spike portion responsive to a pulling force being applied to the infusion adapter.

26. The fluid transfer system of claim 1, wherein the securing mechanism comprises a hinged clip connector joined with the main body of the infusion adapter, the hinged clip connector including a first clip arm and a second clip arm positioned on opposing sides of the main spike portion, and wherein each of the first clip arm and the second clip arm includes:
an engagement portion extending up past a stop of the main body and up along a partial length of the main spike portion, and including a hook or knurling at a far end thereof configured to mate with a collar of the port; and
an actuation portion joined with the engagement portion at an end thereof opposite the hook or knurling, the actuation portion comprising a finger press;
wherein responsive to a pinching force being applied to the finger presses of the first clip arm and the second clip arm, the first clip arm and the second clip arm are caused to separate further, allowing the main spike portion to be pressed into and engaged with the port; and
wherein, upon engaging of the main spike portion with the port and releasing of the finger presses of the first clip arm and the second clip arm, the first clip arm and the second clip arm move back to an initial closed position, where the hook or knurling engages the collar of the port.

27. A method of connecting and securing an infusion adapter with an infusion fluid container, the method comprising:
providing an infusion adapter comprising:
a main body;
a connection spike positioned at a first end of the main body, the connection spike having a main spike portion and a puncturing point configured to engage a port of the infusion fluid container; and
a securing mechanism;
pushing the main spike portion into a port of the infusion fluid container such that the puncturing point pierces a fluid barrier member of the infusion fluid container; and
actuating the securing mechanism to secure the main spike portion within the port, with the securing mechanism restricting vertical movement between the port and the main spike portion to prevent dislodging of the main spike portion from the port.

28. The method of claim 27, wherein providing the infusion adapter comprises providing the infusion adapter with the securing mechanism integrally formed with the main body or the main spike portion.

29. The method of claim 27, wherein providing the infusion adapter comprises pre-fixing the securing mechanism to the main body or the main spike portion prior to pushing the main spike portion into the port.

30. The method of claim 27, wherein actuating the securing mechanism comprises manually actuating the securing mechanism subsequent to pushing the main spike portion into the port.

31. The method of claim 27, wherein actuating the securing mechanism comprises mechanically actuating the securing mechanism as the main spike portion is pushed into the port.
